(19) United States
(12) Patent Application Publication
(10) Pub. No.: US 2025/0045848 A1
(43) Pub. Date: Feb. 6, 2025

(54) AGENT DRIVEN WORKFLOW ENGINE FOR AUTOMATING PROPERTY MANAGEMENT TASKS

(71) Applicant: AppFolio, Inc., Goleta, CA (US)

(72) Inventors: Christfried Hermann Focke, Zurich (CH); Jorge Ezequiel Esposito, Santa Barbara, CA (US); Theodore Chung Hung Ho, Goleta, CA (US); Matthew Brian Schofield, Buena, NJ (US); Thoralf Soeren Thust, Santa Barbara, CA (US); Matthew James Baird, Belmont, CA (US); Sebastian Clemens Kapfer, Erlangen (DE); Zachary Davis, Spring Hill, TN (US); Brynjar Gretarsson, Goleta, CA (US)

(21) Appl. No.: 18/793,498

(22) Filed: Aug. 2, 2024

Related U.S. Application Data
(60) Provisional application No. 63/624,274, filed on Jan. 23, 2024.
(60) Provisional application No. 63/530,935, filed on Aug. 4, 2023.

(51) Int. Cl. G06Q 50/163; G06Q 10/10

(52) U.S. Cl. CPC G06Q 50/163; G06Q 10/103

(57) ABSTRACT

A property management software system (PMSS) receives, from a client device connected to the PMSS, a request associated with a property management task, identifies a workflow corresponding to the property management task, the workflow comprising a sequence of operations, generates a prompt based on the request, the workflow, and additional contextual data from the PMSS, and provides the prompt as an input to a generative AI model agent, the generative AI model agent to execute the sequence of operations to perform the property management task.

### CROSS-REFERENCE AND RELATED APPLICATIONS

This application claims the benefit of U.S. Provisional Patent Application No. 63/530,935; filed on Aug. 4, 2023, the entire contents of which are hereby incorporated by reference herein. This application claims the benefit of U.S. Provisional Patent Application No. 63/624,274; filed on Jan. 23, 2024, the entire contents of which are hereby incorporated by reference herein.

### TECHNICAL FIELD

Aspects and implementations of the present disclosure relate systems and methods for agent driven workflows for automating property management tasks.

### BACKGROUND

Real estate (RE) owners who wish to lease their properties with the goal of generating rental income will need to manage the daily operations, either by themselves or by hiring a separate property management (PM) company. PM operators, administrators, or staff can use property management software systems (PMSS) to aid in the operations of their business, so as to improve efficiencies by automating routine and repetitive tasks that need to be done consistently and in accordance with laws and regulations. Such automation can play a critical role for an owner, especially as a particular real-estate portfolio grows beyond a certain point. By leveraging sophisticated record-keeping and task-management software, PMSSs support property managers through database management, finance management, task management, and communications, as well as providing process visibility and scalability to RE owners, investors, employees, residents, and third-party vendors.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture capable of supporting a property management software system (PMSS), in accordance with embodiments of the present disclosure.

FIG. 2A illustrates an example workflow capable of being generated by the workflow manager of FIG. 1, in accordance with embodiments of the present disclosure.

FIG. 2B illustrates an example definition process for defining a workflow via the workflow manager of FIG. 1, in accordance with embodiments of the present disclosure.

FIG. 3 illustrates an example orchestration engine of the workflow manager of FIG. 1, in accordance with embodiments of the present disclosure.

FIG. 4 illustrates an example deployment and execution process for deploying and executing a workflow via the workflow manager of FIG. 1, in accordance with embodiments of the present disclosure.

FIG. 5 illustrates example support processes for responding to a user query made via the chat module of FIG. 1, in accordance with embodiments of the present disclosure.

FIG. 6A illustrates an example process for routing a user query made within the system of FIG. 1 to a support module, in accordance with embodiments of the present disclosure.

FIG. 6B illustrates an example process for performing support operations within the system of FIG. 1, in accordance with embodiments of the present disclosure.

FIG. 7 illustrates an example process for editing a workflow using the workflow manager and chat module of FIG. 1, in accordance with some embodiments of the present disclosure.

FIG. 8 illustrates an example workflow capable of being generated by the workflow manager and chat module of FIG. 1, in accordance with some embodiments of the present disclosure.

FIG. 9 illustrates an example user interface (UI) for the workflow editor of FIG. 5, in accordance with some embodiments of the present disclosure.

FIG. 10 illustrates an example process for executing an agent-driven workflow, in accordance with some embodiments of the present disclosure.

FIG. 11 illustrates a block diagram of an example processing device operating in accordance with implementations of the present disclosure.

### DETAILED DESCRIPTION

Conventional property management software systems (PMSSs) face some challenges when automating services provided to real estate (RE) owners. By way of examples, such challenges can include the need for customizations that are too natural, or advanced, for conventional PMSSs to produce, as well as addressing the breadth, scale, and complexities of property management (PM) tasks required of a RE owner.

As background to some limitations, today, many PMSSs provide a web-based interface for PM operators or staff to manually perform PM tasks. PM tasks can be completed through manipulating PM information and operating a complex set of pages, menus, and forms. More specifically, such PM tasks can include generating listings for RE units, handling delinquencies, reconciling bank accounts, renewing leases, managing maintenance work orders, generating reports, etc.

Such tasks are often repetitive and predictable in nature, but can incorporate constraints or requirements that current PMSSs are unable to meet. For example, common PM tasks can require customization based on a specific circumstance outside the purview of a PMSS, such as a need for custom and natural elements within important communications or the incorporation of impacting information or events, outside the PMSS's field of view. Such constraints make it challenging to automate PM tasks with rigid software systems, and so, often rely on a human agent to manually manipulate data or complete tasks. Such manual human engagement can increase duration for a task, occupy valuable human capital and material resources, and otherwise inject latency, error, and obscurity into existing PM systems. Additionally, the number and breadth of tasks performed by a PM agent can inject complexity into a correspondingly powerful PMSS and associated processes. This added scale and complexity can become overwhelming, especially for new users of a PMSS, or in dealing with rarely occurring tasks and situations. Such complexity can at times negate the added efficiency, accuracy, and other benefits commonly associated with task automation.

A sequence of PM tasks and their timing (e.g., a “workflow”), often needs to be individualized, while still maintaining elements of repeatability. A workflow as described herein refers to a series of steps or a process designed to accomplish a specific task or set of tasks. They can be as simple as a checklist or as complex as a multi-stage process with conditional flow paths. For example, PM workflows are often associated with recurring PM events like move-outs, renewals, or rent collections.

Within a PMSS, a workflow can be generated, represented, and edited at varying levels of abstractions. Depending on the implementation, a workflow can be defined as code or Domain Specific Language (DSL), (e.g. a JSON), which can then be rendered as a flow-chart. Not all workflows representable by code can be represented as DSL, however, and therefore such workflows may not be rendered as flow-charts.

A particular property manager may wish to individualize their specific set of workflows (i.e., a PM “playbook”) for these events, to address their unique circumstances and constraints. Such individualized workflows can introduce requirements for additional training or supervision for associated agents or staff, to maintain consistent experiences and expectations for residents and stakeholders, and to ensure compliance with any applicable regulations. Implementing mechanisms for adding such training or supervision can engage substantial human capital, require significant time-investment, and otherwise strain a property manager's bandwidth.

Thus, aspects and implementations of the present disclosure address the above and other deficiencies by introducing systems and methods for a PMSS leveraging the use ofs. As will be described in more detail below, the system described herein can provide for a workflow manager to enable the generation of workflows related to different property management tasks. Once generated, these workflows can be utilized to guide large language AI model (LLM) agents in the automated execution of the corresponding property management tasks.

In embodiments, the workflow manager and chat module can enable rapid and versatile creation, customization, and execution of workflows. In embodiments, the provided workflow manager provides design, automation, and optimization of workflows across humans, APIs, and AI. In addition, a runtime environment and orchestration engine of the workflow manager can provide an external metadata configuration format that allows users to change workflow definitions in near real-time, without redeploying software.

In embodiments, the workflow manager can provide one or more unique user interfaces (UIs) for interfacing with a workflow repository (to store user-defined workflows), an orchestration engine (to execute workflows) and a workflow editor (for editing workflows). In embodiments, the workflow manager can leverage the functionality of one or more intelligent agent(s) (e.g., such as a large language AI model (LLM)). The workflow manager can provide access to intelligent functionalities to a user through a chat module, or access the intelligent functionalities directly (e.g., through an API call). For instance, a user of the PMSS can generate and/or edit a workflow through a chat module UI, or through an editor UI of the workflow manager.

In embodiments, the above mentioned workflows can be utilized by various business logic components of the PMSS to guide execution of one or more intelligent agents, such as large language model (LLM) agents, that can perform tasks pertaining to a set of instructions. In some embodiments, the LLM agents can be fine-tuned on a specific domain of a PM business unit (e.g., the financial unit). In some embodiments, the LLM agents can be fine-tuned for supporting PMSSs in general. An LLM agent can refer to a component that can autonomously interact with its environment, make decisions, and perform actions based on the input it receives. In the context of LLMs generative AI, this means that an agent can reason about the inputs, and take or suggest actions to advance the workflow on behalf of a human operator, with varying levels of supervision.

In some embodiments, during the execution stage of a predefined workflow, the system can intake a user query via an input feature (e.g., chat interface), analyze the query (with or without the AI model functionalities), validate and/or sanitize the query, and route the user query to an appropriate support module from several available support modules, that each perform further processing and sub operations associated with the query. In some embodiments, the LLM agent can route the query to more than one support module, and then collect responses from one or more support module. In some embodiments, several support modules can be associated with the LLM agent. A single support module, for example, can perform more focused tasks or support operations, including further subprocesses, or retrieval of data associated with the query (again, with or without the AI model functionalities).

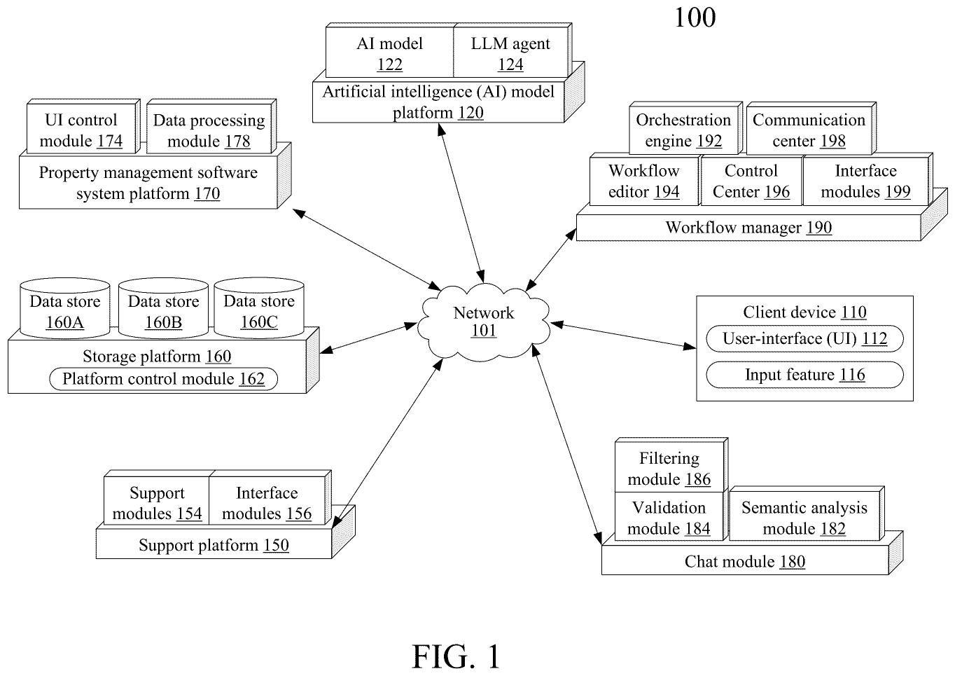

FIG. 1 illustrates an example system architecture capable of supporting a property management software system (PMSS), in accordance with embodiments of the present disclosure. The system architecture 100 (also referred to as “system” or “PMSS” herein) includes one or more client device(s) (e.g. client device 110), an artificial intelligence (AI) model platform 120, a support module platform 150, a storage platform 160, and a property management software system (PMSS) platform 170, a chat module 180, and a workflow manager 190, each connected to a network 101. In some embodiments, client device 110, artificial intelligence (AI) model platform 120, support module platform 150, storage platform 160, PMSS platform 170, chat module 180, and workflow manager 190 can include, be, or otherwise be connected to one or more computing devices, (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components capable of connecting to system 100.

In some embodiments, network 101 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments of the system, the system 100 can include a property management software system (PMSS) platform 170 for hosting the PMSS, that can perform overall control of modules and devices associated with the platform (e.g., through a control module, not shown in FIG. 1). Platform 170 can further include a user-interface (UI) control module 174 for performing UI generation for one or more client devices, and other processes associated with the UI that will be presented to a user. Platform 170 can further include a data processing module 178, that can gather, manage, and process data (e.g., such as data gathered from support module platform 150 or storage platform 160). In embodiments, data processing module 178 can process, transmit, and receive, incoming and outgoing data. A chat module 180 can host, process, route and provide responses to user inputs associated with the chat functionalities. The workflow manager 190 can enable, edit, and execute workflows (as directed by user-inputs). These components can work collaboratively, and communicate internally, or externally (e.g., to further systems and/or through APIs), to facilitate PMSS capabilities for users across a range of client devices.

As described above, platform 170 can facilitate connection of client devices (e.g., client device 110) to the system 100. Platform 170 can facilitate connecting any number of client devices associated with any number of users. In embodiments, platform 170 can support textual transfer capabilities, or any data transfer of any data types relevant or associated with a PM task. In embodiments, platform 170 can synchronize and deliver digital communications, such as text, impressions, emoji, audio, video, etc., and other kinds of communications data to client devices with minimal latency.

In embodiments platform 170 can interface with other platforms of the system 100 and can act as a bridge, facilitating the low-latency exchange of communications data between client devices, modules, and platforms during use of the PMSS. In embodiments, platform 170 can implement the rules and/or protocols for facilitating client device connections, and can provide supporting structures, such as UIs and/or communications management for client devices connected to the system.

Platform 170 can orchestrate the overall functioning of the PMSS platform 170 (e.g., through a control module, or similar). In some cases, platform 170 can include algorithms and processes to direct the setup, data transfer, and processing required for providing PMSS services to a user. For example, when a user initiates engagement with the PMSS, platform 170 can initiate and manage the associated process, including allocating resources, determining routing pathways for data streams, managing permissions, and so forth interact with client devices to establish and maintain reliable connections.

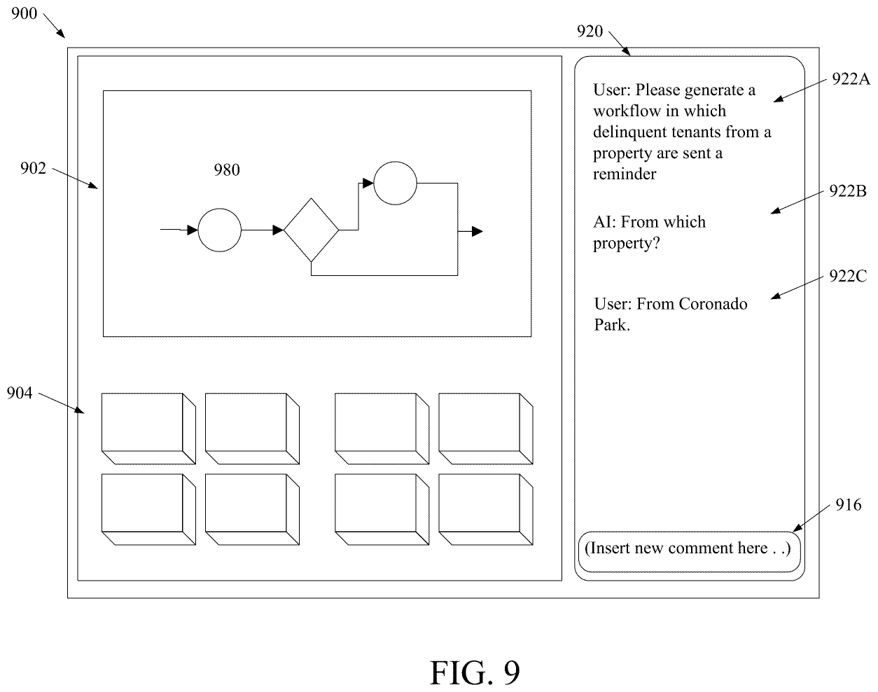

UI control module 174 can perform user-display functionalities of the system such as generating, modifying, and monitoring the individual UI(s) and associated components that are presented to users of the platform 170. For example, UI control module 174 can generate the UI(s) (e.g., graphical user-interfaces (GUIs)) that users interact with during use of the PMSS. As will be further discussed with respect to FIG. 9, a UI can include many interactive (or non-interactive) visual elements for display to a user. Such visual elements can occupy space within a UI and can be visual elements such as windows displaying video streams, windows displaying images, chat panels, file sharing options, participant lists, or control buttons for functions such as navigating the system, requesting data or documents, engaging in chat functionality, and so forth. The UI control module 174 can work to manage such a UI and associated elements, including generating, monitoring, and updating the spatial arrangement and presentation of such visual elements, as well as working to maintain functions and manage user interactions. Additionally, the UI control module 174 can adapt the interface based on the capabilities of client devices. In such a way the UI control module 174 can provide a fluid and responsive interactive experience for users of the PMSS.

In some embodiments, the data processing module 178 can be responsible for the acquisition and management of data. This can include gathering and directing data received from a user of the PMSS, gathering and directing data received from support module platform 150 and/or data stores (e.g. such as data stores 160A/B) or other platforms (such as chat module 180 and/or workflow manager 190), or connection to third-party data providers. Data processing module 178 can also be responsible for communicating with external data storage (e.g., data store 160A-B, repository 160C, and/or storage platform 160), to store received data, or acquire previously stored data for manipulation or transmission. Thus, module 178 can not only direct storage of acquired data but often also manages metadata associated with such data, including titles, descriptions, data-types, thumbnails, and more.

Data processing module 178 can further receive, process, and transmit data to and/or form associated client devices. In some cases, data processing module 178 can be equipped to receive, transmit, encode, decode, compress, or otherwise process data for efficient delivery to or from devices, modules, or platforms, etc. (in embodiments, as controlled by platform 170 and any embedded control modules). Once data processing module 178 has received and processed internal data (as described in previous paragraphs), module 178 can transmit the data to associated client devices over a network (or any other connection method). Depending on the network conditions and capabilities of each client device, different versions of the same data can be sent to different devices to ensure the best possible quality of data for each user.

Some data, such as textual input (e.g., chat inputs, comments, or other textual commands associated with the PMSS, etc.), participant reactions, and control commands may not be received by the data processing module 178, but instead by other modules or subsystems of the platform 170 (and/or further platforms such as chat module 180, workflow manager 190). In any case, the receiving body can process specific inputs and coordinate with other modules to perform associated tasks (e.g., update UIs, store data, update system indicators for connected devices and modules, etc.). For example, in the case of PMSS navigation command (e.g. received via a navigation control bar, or similar implementation, of the UI), platform 170 can ultimately receive the navigation command, and work with the other modules of the system to affect the user navigation request. In the case of a different control command, like a selection of a document for viewing at the client device, platform 170 (e.g., through an embedded control module) can direct the data processing module 178 to acquire the necessary data from storage platform 160, and direct data processing module 178 and UI control module 174 to effectively transfer such a document and its associated data to the connected client device. In such a way, transmitting, receiving, and processing of data by the PMSS platform 170 from one or more connected client devices (e.g., client device 110) can be coordinated in tandem with other associated modules and platforms, as seen in FIG. 1.

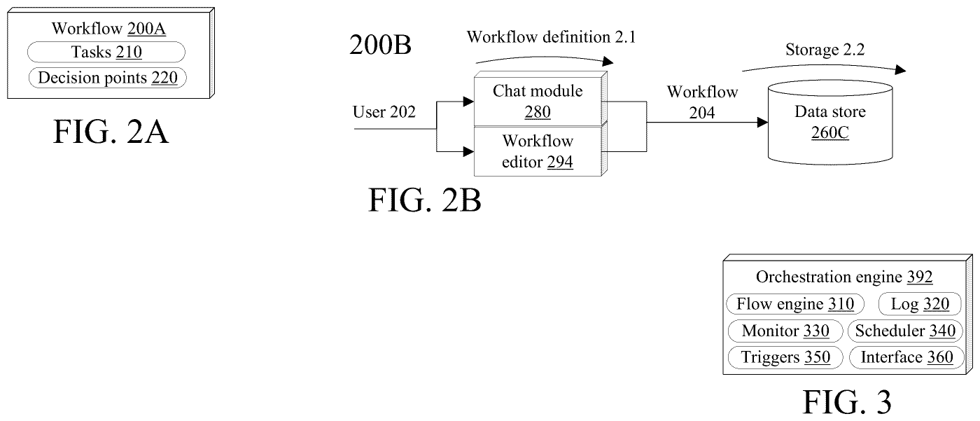

Some user inputs related to the chat and/or workflow functionalities of the PMSS system received from a client device 110 can require further processing (as will be described in further detail with respect to FIGS. 2-9). If determined as necessary, the platform 170 can leverage chat module 180 and/or workflow manager 190 (or chat module 180, workflow manager 190 can receive such user inputs directly), AI models associated with the system, and support module platform 150, to properly engage with the user inputs (e.g., such as a chat-directed query). For instance, when a user transfers a user query through the chat functionalities to the PMSS with the intent of retrieving data, such information can ultimately be transferred to, and handled, by chat module 180. Upon receiving such a query, chat module 180 can process such data internally, coordinate with AI model platform 120, query processing functionalities and/or support module platform 150, to generate a response to such a user query. Ultimately (as will be discussed in further detail with respect to FIG. 2), chat module 180 can perform an operation, direct other modules and platforms to perform operations (e.g., such as a support operation), or communicate with external APIs to transfer instructions and data. Such operations can include, for example, retrieving a document, article, or information for display to the user, sending one or more emails, or providing a text response, etc.

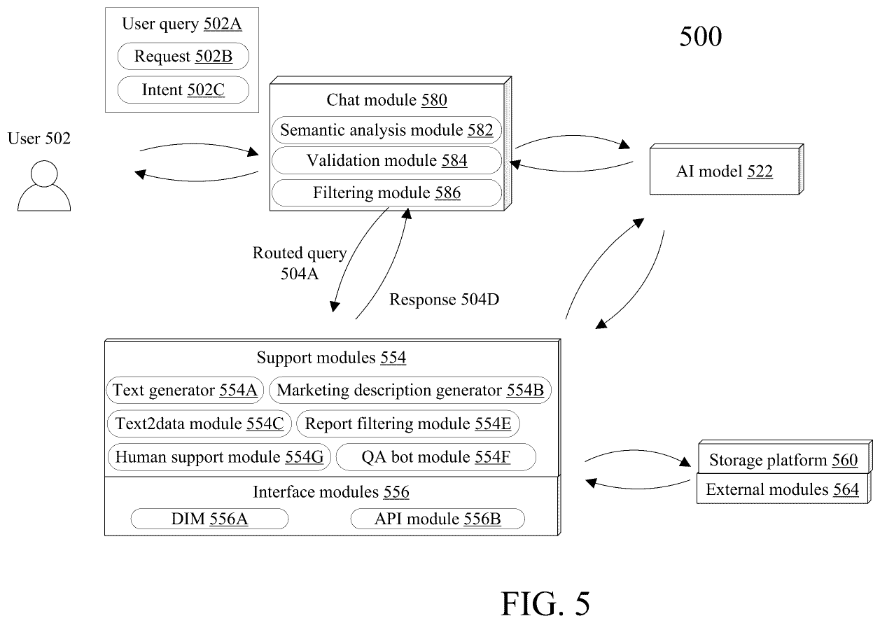

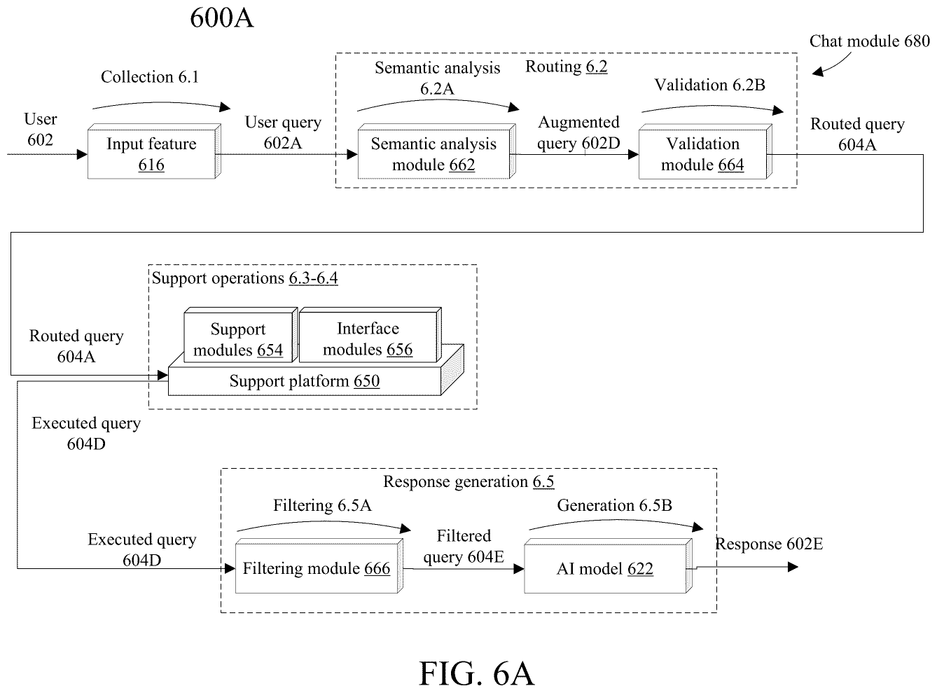

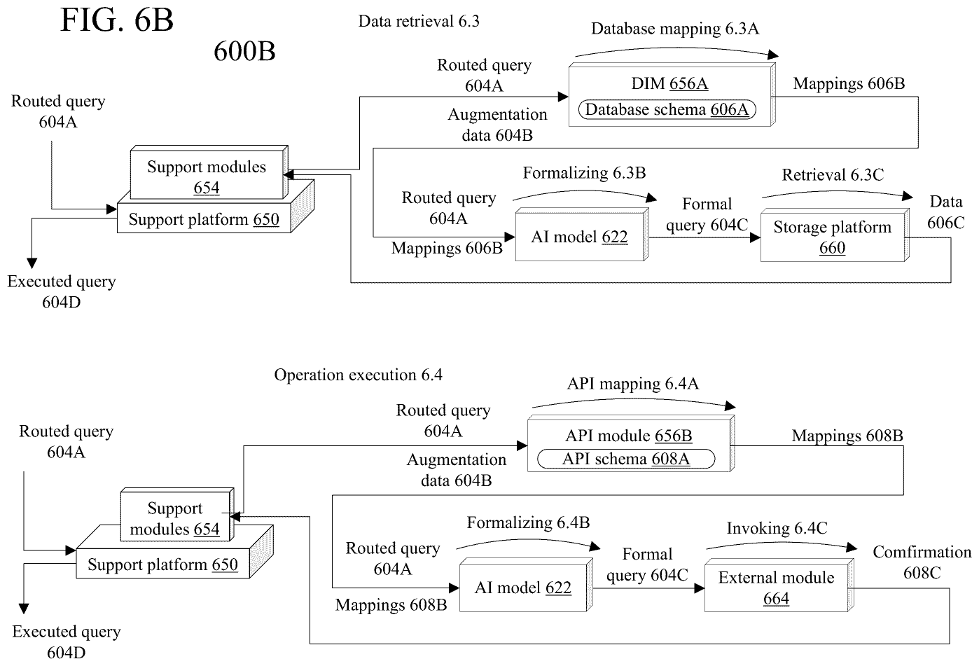

In some embodiments, chat module 180 can receive an input user query, perform semantic analysis, validate the query, filter (if necessary), and route to an appropriate support module of support modules 154 (support modules 154 can include several support modules, as will be further described with respect to FIG. 5). These processes will be further discussed with respect to FIGS. 5 and 6A-B below.

In some embodiments, one or more client devices (e.g., client device 110) can be connected to the system 100. In some embodiments, the client device(s) can each include computing devices such as personal computers (PCs), laptops, mobile phones, smart phones, tablet computers, netbook computers, notebook computers, network-connected televisions, etc. In some embodiments, client device(s) can also be referred to as “user devices.”

Client devices, under direction by the property management system platform, when connected, can present (e.g., display) a UI to a user of a respective device. Such a UI can include various visual elements and can be the primary mechanism by which the user engages with the PMSS platform, and the PMSS at large.

In some embodiments, client devices (e.g., client device 110) connected to the system can each include a client application (not shown in FIG. 1). In some embodiments, a client application can be an application that provides a user interface (UI) (e.g., UI 112), sometimes referred to as a graphical user interface (GUI)) for users to transmit and receive data from the system at large. In some embodiments, the system (or any associated platforms), can transmit any data, including audio, video, and textual data, to the client device. Such data that can be received by the client application for display in the UI and can include, for example, textual information, document information, information associated with the PMSS at large, or queries or decisions for which the platform requires user input.

In some embodiments, the client application (e.g., that provides the UI) can be, or can include, a web browser, a mobile application, a desktop application, etc. In one or more examples, a user of a client device can input textual data (e.g., a user query) into an input feature (e.g., input feature 116) or the client application, to provide a query to the PMSS, and associated modules.

In some embodiments, the client device can capture audio, video, and textual data from a user of the client device and transmit the captured data to the PMSS platform. Such data can include audio, video, and textual data from a user of the client device. In some embodiments, the client device can transmit the captured data to any of the system platform(s) for further processing. Such captured data can be any kind of input data associated with a conventional mouse and keyboard, or other similar input system (e.g., that associated with other types of client devices). Such data can be transmitted to any system platform and/or any of its associated modules. In an example, such captured data that can be transmitted to the PMSS platform can include, textual or PM data that a user intends for storage, inputs or directives for the PMSS and/or any of its associated modules to execute a task, or user queries for the PMSS platform to generate a response (as will be discussed in further detail with respect to FIG. 5).

As will be described in further detail with respect to FIG. 9, In some embodiments, the UI(s) can include one or more UI element(s) that support a user input feature 116 (e.g., such as a query space, or an audio feature incorporating speech-to-text capabilities). Such an input feature 116 can be used by the user to provide input or a query for the chat functionalities of the PMSS platform, or the PMSS at large.

In some embodiments, as will be discussed in further detail below, functionalities of the system 100 (and the PMSS at large) can leverage an artificial intelligence (AI) model platform 120, for accessing and communicating with an AI model (e.g., AI model 122) and/or an AI agent (e.g., LLM agent 124). In some embodiments, platform 120 can include an interface (not shown in FIG. 1) for communicating to and from the AI model 122 and the LLM agent 124.

In some embodiments, the AI models 122 of platform 120 can be generative large language models (LLMs) (e.g., in some embodiments the AI models of platform 120 can be an instance of Google's Bert, or OpenAI's series of ChatGPT language models, or any other LLM). As will be discussed further below, the AI model can be pre-trained, and capable of processing and responding to natural language inputs with coherent and contextually relevant text.

In some embodiments, AI model(s) can be (or can correspond to) one or more computer programs executed by processor(s) of AI model platform 120. In other embodiments, an AI model can be (or can correspond to) one or more computer programs executed across a number or combination of server machines. For example, in some embodiments, a self-hosted AI model 122 can be hosted within a proprietary PMSS, or within a proprietary server or hardware system, while external AI model 122 can be any existing AI model accessible via an external API (e.g., accessible on the internet).

In some embodiments, LLM agent 124 represents a sophisticated AI system that can leverage large language models, such as AI model 122, to understand and generate human language in context. LLM agent 124 can go beyond basic text generation by maintaining conversation threads, recalling previous statements, and adapting their responses with different tones and styles. In addition, LLM agent 124 can perform multistep reasoning and tool calling to interface with external systems and respond with structured responses that can drive traditional software systems. These capabilities enable LLM agent 124 to handle complex tasks such as problem-solving, content creation, conversation, and language translation. Consequently, LLM agent 124 finds applications in fields like customer service, copywriting, data analysis, education, and property management. Property managers or business logic units of the PMSS platform 170 can guide LLM agent 124 through prompts, which include queries, instructions, and context. Using the workflows generated by workflow manager 190, LLM agent 124 can perform tasks autonomously by self-directing its actions. This autonomy enhances effectiveness in assisting property managers by combining user prompts with self-directed capabilities. As a result, LLM agent 124 can drive productivity, reduce menial tasks, and solve complex problems.

In some embodiments, the chat module 180 can include or access query processing functionalities and modules (as will be further described with respect to FIGS. 5-6B). Query processing modules can include a semantic analysis module 182, a validation module 184, and a filtering module 186. In embodiments, the query processing modules can manipulate the query data and format to either prepare the data for transfer to a specific platform, module, or API, or extract information about the query, so as to make determinations about how to further process the query. These modules and processes, as well as others, will be further discussed with respect to FIG. 5-6B below. These modules and functionalities can also be accessed by other modules and platforms of system 100.

In some embodiments of the system, as will be discussed in further detail below with respect to FIGS. 5, and 6A-B, the system 100 can include a support module platform 150 for performing support operations and responding to user queries (e.g., that have been routed via chat module 180). Support module platform 150 can include support modules 154, and interface modules 156. Support modules 154 can be a variety of support modules (as will be discussed below) for performing support operations. Support modules 154 can leverage interface modules 156, to query and access other modules of the system (e.g., AI model 122, etc.), internal or external APIs, data platforms (e.g., including data stores), etc. Interface module 156 can include a database interface module. The support module platform can be leveraged by chat module 180 and/or workflow manager 190 to complete operations related to a user query and/or workflows associated with the system.

In embodiments, as will be discussed in further detail below with respect to FIGS. 2-9, the system 100 can include a workflow manager 190 for generating, editing, storing, and executing a workflow associated with the PMSS. Workflow manager 190 can include orchestration engine 192 for executing one or more workflows, a workflow editor 194, a control center 196, and a communication center 198.

Orchestration engine 192 (which will be described in further detail with respect to FIG. 3) can be a unified orchestration engine that powers all workflows (e.g., engine 192 can be decoupled with UIs); the engine can utilize data events to trigger workflows and data, action, and communication APIs to complete actions.

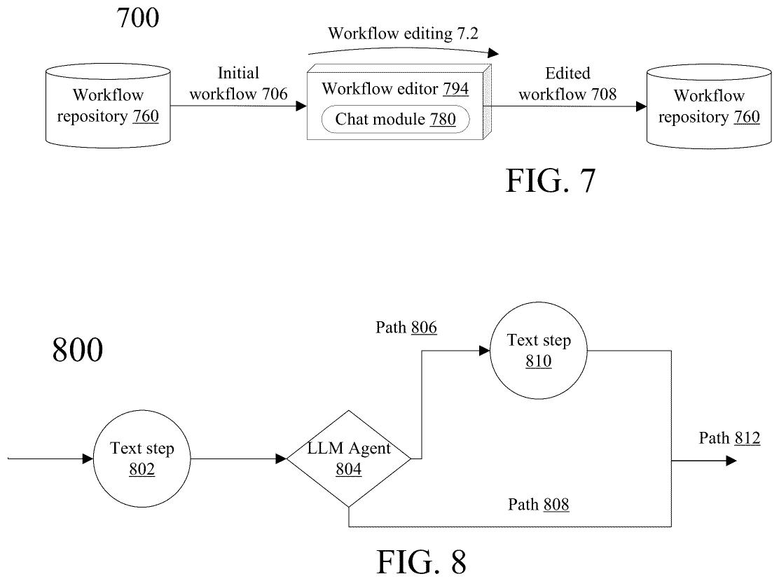

Workflow editor 194 of workflow manager 190 (which will be described in further detail with respect to FIGS. 7-9) can be used to edit (and/or generate) one or more workflows. Editor 194 can include one or more interfaces or UIs associated with the editor. In embodiments, a UI associated with the editor can include a chat interface, and support chat functionality powered by the chat module 180. In embodiments, the editor can be leveraged to provide a way to visually model workflows as a graph of tasks, decision points, and transitions. This can allow abstract definitions of different workflows.

Workflow manager 190 can further include a control center 196 for allowing a user to manage macro functionalities of the workflow manager (e.g., via a control dashboard of a UI). In embodiments, the control center 196 can be associated with a UI, e.g., such as a unified dashboard of all workflows. Actions requiring human intervention can appear in such a UI, extending to insights and recommendations in the future. In embodiments, the UI associated with the control center 196 can be a dashboard-like task tracker. Such a UI can enable users to understand exactly which workflows are in progress, what stage workflows are in, review completed actions, and be notified of steps requiring manual intervention. Control center 196 can thus be a centralized tool that users will interact with to monitor and audit workflows.

In embodiments, the workflow manager 190 can be supported by backend components. In embodiments, backend components and functionality can be embedded, or internal, to the workflow manager 190; alternatively, backend components can be separate from workflow manager 190. In embodiments, such backend components may be accessed and interfaced with via interface modules 199 of workflow manager 190.

As will be described in further detail with respect to FIGS. 2B-4, the workflow manager 190 can leverage functionalities of at least AI platform 120, chat module 180, support modules 154 (and other modules and functionalities external to the system) through interface modules 199. In embodiments, modules 199 can support development and deployment of machine learning capabilities, including support for large language models (LLMs).

In embodiments, one or more interface modules 199 of workflow manager 190 can be, include, or access one or more APIs, such as a data API, an actions API, and/or a communications API. In alternate embodiments, such APIs may be included within interface modules 156 of support module platform 150, which may be leveraged by workflow manager 190.

In embodiments, a data API of interface modules 199 can include or be a curated API for user data that is transformed and optimized for all reporting and analytics, as well as for answering customer queries. An actions API of interface modules 199 can be a collection of APIs for taking action or completing tasks. A communications API of interface modules 199 can be a set of APIs that abstract the implementation details of the “pipes” for all communication, including email, SMS, in-app, and more.

In embodiments, the communication center 198 can be a unified inbox, or a single space for managing all communication channels. Communication center 198 can be used to introduce a level of automation, and streamline, repetitive communications. Center 198 can further allow all stakeholders to interact with the PMSS 100 using whichever communication channel they prefer. In embodiments, center 198 can include a UI component (e.g., an associated dashboard), and can allow property managers to oversee all communications grouped by the stakeholder or use case.

As discussed, in embodiments, multiple UIs, or UI components can exist for the components of workflow manager 190. E.g., multiple UIs, or UI components can exist for chat interfaces, workflow (e.g., sequence) designers or editor 194, the communication center 198, control center 196, engine 192, and other UIs, as necessary. While there can be various UIs used to create and edit workflows (e.g., standard vs custom workflows), the command center can track details of all workflows to be advantageous to the user experience.

In some embodiments, storage platform 160 can host and manage data stores 160A-C. In some embodiments, data store 160A can be a persistent storage that is capable of storing structured data (e.g. graphs, tables, spreadsheets pertaining to e.g., vendor names, order numbers, dates, etc.) and associated metadata, while data store 160B a persistent storage that is capable of storing unstructured data (e.g., video, text, or vectorized data, etc. pertaining to documents, emails, videos, etc.) and associated metadata. Data store 160C may be a repository for workflows (e.g., as generated by workflow manager 190). In some embodiments, storage platform 160 can include a platform control module 162 (e.g., a database manager) to manage and respond to database requests. In embodiments, data stores 160A-C may be physically separate. Alternatively, data stores 160A-C may be combined, or be segments of a larger, unified data store.

In embodiments, any of the modules and or platforms can host or leverage an AI model 122 for performing processes associated with the respective module.

In one embodiment, such an AI model can be one or more of decision trees, random forests, support vector machines, or other types of machine learning models. In one embodiment, such an AI model can be one or more artificial neural networks (also referred to simply as a neural network). In one embodiment, processing logic performs supervised machine learning to train the neural network.

As indicated above, such an AI model can be one or more generative AI models, allowing for the generation of new and original content, such a generative AI model can include aspects of a transformer architecture. Such a generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. Further details regarding generative AI models are provided herein.

In some embodiments, such an AI model can be an AI model that has been trained on a corpus of textual data. In some embodiments, the AI model can be a model that is first pre-trained on a corpus of text to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, such an AI model can be capable of being directed via user-generated prompts. In embodiments, such an AI model can be “steered” via user-generated prompts. For example, the prompting can be done programmatically and may consist of a series of prompts (e.g., reasoning, tool calling, tool response interpretation, calling of other agents, requesting human input, etc.).

In embodiments, the AI model can then be further trained and/or fine-tuned on organizational data, including proprietary organizational data, or provided with additional context in the prompt. The AI model can also be further trained and/or fine-tuned on organizational data associated with a PMSS, or PM systems at large.

In embodiments, such an AI model can include one or more pre-trained models, or fine-tuned models. In a non-limiting example, in some embodiments, the goal of the “fine-tuning” can be accomplished with a second, or third, or any number of additional models. For example, the outputs of the pre-trained model can be input into a second AI model that has been trained in a similar manner as the “fine-tuned” portion of training above. In such a way, two more AI models can accomplish work similar to one model that has been pre-trained, and then fine-tuned.

In some embodiments, a first AI model can dynamically generate prompts for a second AI model (or other software component such as a database). For instance, with respect to data retrieval, a first AI model can leverage a database schema (e.g., a simplified view of available data that is understandable without expert domain knowledge, and including natural language descriptions) to generate a formal prompt to index and retrieve relevant subsets of tables for a given user query. In some embodiments, the AI model(s) can include a retrieval component of a retrieval-augmented generation (RAG) system for providing context associated with the request to the generative AI model.

In some embodiments, data stores 160A-C can be hosted by one or more storage devices, such as main memory, magnetic or optical storage-based disks, tapes or hard drives, network-attached storage (NAS), storage area network (SAN), and so forth. In some embodiments, data stores 160A-C can be a network-attached file server, while in other embodiments, data stores 160A-C can be some other type of persistent storage such as an object-oriented database, a relational database, and so forth. In some embodiments, data stores 160A-C can be hosted by any of the platforms or devices associated with system 100 (e.g., support module platform 150). In other embodiments, data stores 160A-C can be on or hosted by one or more different machines (e.g., the PMSS platform 170 and support module platform 150) coupled to the storage platform via network 101.

In some implementations, the data stores 160A-B can store portions of audio, video, or text data received from the client devices (e.g., client device 110) and/or any platform and any of its associated modules.

In some embodiments, any one of the associated platforms (e.g., the PMSS platform 170) can temporarily accumulate and store data until it is transferred to data stores 160A-C for permanent storage.

In general, functions described in embodiments as being performed by any of the system platforms, can also be performed by the client device(s) of the system. In addition, the functionality attributed to a particular component can be performed by different or multiple components operating together. Any of the system platforms or modules can also be accessed as a service provided to other systems or devices through appropriate application programming interfaces (APIs), and thus is not limited to use in websites.

It is appreciated that in some other implementations, the functions of platforms 120, 150, 160, or 170, and/or chat module 180 and workflow manager 190, can be provided by a fewer number of machines. For example, in some implementations, functionalities of platforms 120, 150, 160, and/or 170, and/or chat module 180 and workflow manager 190, can be integrated into a single machine, while in other implementations, functionalities of platforms 120, 150, 160, and/or 170, and/or chat module 180 and workflow manager 190, can be integrated into multiple, or more, machines. In addition, in some implementations, only some platforms of the system can be integrated into a combined platform.

In general, functions described in implementations as being performed by platforms 120, 150, 160, and/or 170, and/or chat module 180 and workflow manager 190, can also be performed by the client devices (e.g., client device 110). In addition, the functionality attributed to a particular component can be performed by different or multiple components operating together. Platforms 120, 150, 160, or 170, and/or chat module 180 and workflow manager 190, can also be accessed as a service provided to other systems or devices through appropriate application programming interfaces, and thus is not limited to use in websites.

It is appreciated that in some implementations, platforms 120, 150, 160, or 170, and/or chat module 180 and workflow manager 190, or client devices of the system (e.g. client device 110) and/or data stores 160A-C, can each include an associated API, or mechanism for communicating with APIs. In such a way, any of the components of system 100 can support instructions and/or communication mechanisms that can be used to communicate data requests and formats of data to and from any other component of system 100, in addition to communicating with APIs external to the system (e.g. not shown in FIG. 1).

In some embodiments of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline, such as a topic channel.

FIG. 2A illustrates example workflow capable of being generated by the workflow manager of FIG. 1, in accordance with embodiments of the present disclosure. Components, processes, and features as seen and described with respect to FIG. 2A can correspond, or be similar, to similar components as seen and described with respect to FIG. 1. Thus, embodiments discussed with respect to FIG. 2A, can incorporate and augment at least the embodiments described with respect to FIG. 1.

As seen in FIG. 2A, a workflow 200A can be or include one or more tasks 210, and decision points 220.

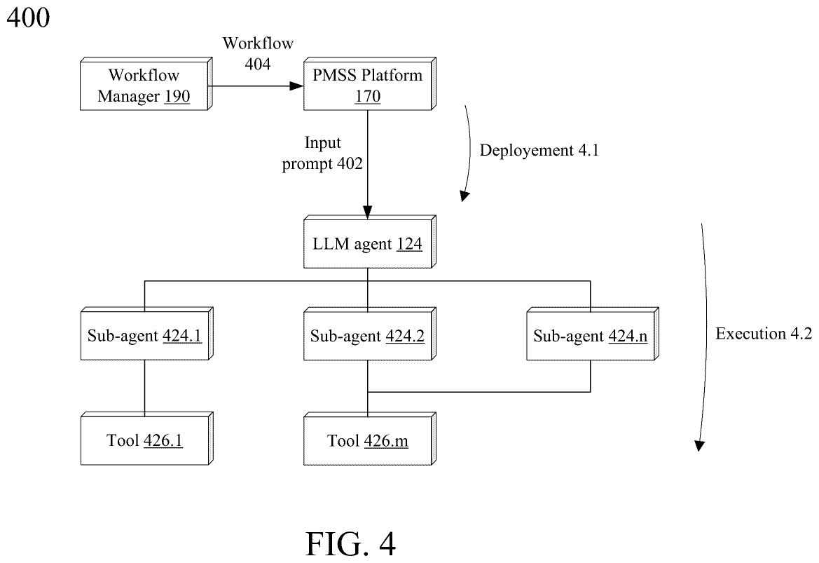

Tasks 210 can include any tasks capable of being executed by the PMSS (e.g., system 100 as described within FIG. 1), and can include tasks ranging from generation of a document, retrieval of data, etc. Tasks 210 can further include further granularized tasks e.g., such as the steps taken to generate a document or retrieve data. As such, tasks 210 can include generation of API calls, generation of data, transmission of data to an external module, etc., according to further levels of granularity, as necessary. In embodiments tasks 210 may be executed by one or more support modules, AI models, and/or modules external to the PMSS. Such processes will be described in further detail with respect to FIGS. 4-6B. Decision points 220 (at times referred to as “gateways”) can be points that determine the direction of the workflow based on certain conditions (e.g., such as user confirmations, user inputs, occurrence of events, conditional logic, etc.).

In embodiments, a workflow (e.g., workflow 200A) can be a sequence of tasks 210 indicated by a user of the PMSS. In embodiments, workflows such as workflow 200A can be manually created and actions (e.g., tasks 210 and decision of decision points 220) can also be manually completed. For instance, any sequence of actions that a user repeatedly takes can be a workflow. For example, tasks 210 and decision points 220 can be or include actions such as scheduling, business logic, notifications, task management, and so on and so forth.

Workflows (e.g., workflow 200A) can be or include a linear sequence of tasks 210 or decision points 220 (e.g., at times referred to as a flow, a flow path, etc.). In embodiments, decision points 220 and/or tasks 210 of a linear sequence can be a bifurcation point, where a flow path of the workflow splits into one or more flow paths (e.g., based on conditional logic, user-inputs, etc.). Thus, steps within a workflow may be linear, or may be complex flows with bifurcations, decision nodes, loops, and so on and so forth. Such a flow path will be further described with respect to FIG. 8.

To allow for additional customization, tasks 210 and/or decision points 220 of a workflow can be scheduled in any order and number, and can be contingent on certain events or inputs. E.g., tasks 210 and decision points 220 can be scheduled to occur in the future (e.g., based on the arrival of a certain data and time, on an event, and so on and so forth.

Workflows associated with the PMSS (e.g., workflow 200A) can further be segregated into standard or custom workflows. Standard workflows can be commonly used workflows, containing universally used tasks and decision points. Custom workflows can be further tailored by a user of the PMSS, according to his or her desired processes. Thus, in embodiments, the workflow manager (e.g., of FIG. 1) can provide a centralized tool for managing both standard and custom workflows.

Standard workflows can be pre-defined into the PMSS, taking into account real estate best practices. These types of workflows can use a static combination of data APIs and actions APIs (e.g., via support modules 154 of FIG. 1). Typical tasks within standard workflow can be associated with, for example, universal events such as tenant move-in, tenant move-out, work-order creation, etc. For example, a standard workflow for a user can be or include paying a bill via the PMSS, and can be customizable with respect to who needs to approve a certain type of bill, etc. E.g., a standard sequence of tasks and decision points for such a flow can be: “waiting for review >pending approval >ready for payment >paid.”

Custom workflows can be defined by users taking into account the idiosyncrasies of their business. In this type of workflow, users can combine data APIs, action APIs, and LLMs to customize and define their own processes. In embodiments, custom workflows can be able to copy existing workflows, and create a custom process using flow diagrams with full editing capabilities (e.g., within an editor of the workflow manager). Such a process will be described in further detail below and further with respect to FIG. 7.

Workflows can further be segregated into static workflows, and dynamic workflows. Workflows can be considered static workflows, e.g., if they constantly execute the same sequence of steps. For instance, a static workflow can include a task for distributing a bulk communication to tenants of a property. Such a task may include constant subtasks where all tenants of a property are first filtered, and subsequently sent a bulk communication over email or text message.

In embodiments, workflows can be considered dynamic if the sequence of bulk actions on multiple entities changes (e.g., as a function of a dynamic variable). For instance, a dynamic workflow associated with a delinquent tenant can include a bifurcation in the logic where a bifurcated flow path can be selected based on the delinquent amount. As discussed, workflows can be a linear sequence of steps, or more complex flows with branches, flow paths, and decision nodes.

The workflow manager can complement the chat module and allow users to schedule out sequences of tasks in the future. Tasks can be a combination of data retrieval and actions, and are processed automatically on the scheduled day.

FIG. 2B illustrates an example definition process for defining a workflow via the workflow manager of FIG. 1, in accordance with embodiments of the present disclosure. Components, processes, and features as seen and described with respect to FIG. 2B can correspond, or be similar, to similar components as seen and described with respect to FIG. 1. Thus, embodiments discussed with respect to FIG. 2B, can incorporate and augment at least the embodiments described with respect to FIGS. 1.

The workflow definition process 200B can include workflow definition 2.1, and storage 2.2. At operation 2.1 of process 200, a user 202 can use the chat module 280 or the workflow editor 294 to generate a workflow 204. In some embodiments workflow 204 can be composed. For example, a scheduling workflow may be reused in different contexts. After, a generated workflow 204 can then be stored in a workflow repository (e.g., data store 260C).

In embodiments, a chat interface (e.g., as powered by chat module 280) of the workflow editor can be used to ask questions and take action, all in natural language, to reduce the onboarding time and the rate of effort for using the PMSS. In embodiments, the chat interface can be an exploratory area of the UI for users to interact with functionalities of the PMSS (e.g., through support modules and AI models of the system) using plain English. In embodiments, the chat interface can be connected, or embedded within, a UI pertaining to the workflow editor 294 to create an integrated experience. Such a UI will be described in further detail with respect to FIG. 9.

In embodiments, the workflow editor 294 (referred to as a designer, in some cases) can be used to define sequences of actions, such as tasks and decision points. Such actions can be scheduled and/or event driven. These can be a natural extension of actions taken or described within a natural language chat within a chat interface of the workflow editor 294. Editor 294 can thus allow users to create custom workflows. In embodiments, workflow editor 294 can be a flow diagram builder that enables users to create and adapt workflows to their business.

Additionally, workflow editor 294 can integrate AI functionality (e.g., through chat module 280 and/or AI models of the system) into the process of creating (and editing) workflows. This can enhance development speed and user experience. For instance, leveraging the chat module and/or one or more AI models of the system, natural language text can be translated into steps leveraging the support modules and interface modules of the system. This can drastically reduce the need for complex interfaces. For example, a user can generate a workflow via the chat interface of the workflow editor 294 (or the chat module 280) by inputting the following into a chat box: “Step 1: list all tenants living in Coronado Park. Step 2: send an email reminding them to bring in their trash bins.” In embodiments, the system can then generate a workflow of bulk actions based on this input.

FIG. 3 illustrates the example orchestration engine of the workflow manager of FIG. 1, in accordance with embodiments of the present disclosure. Components, processes, and features as seen and described with respect to FIG. 3 may correspond, or be similar, to similar components as seen and described with respect to FIGS. 1-2B. Thus, embodiments discussed with respect to FIG. 3, may incorporate and augment at least the embodiments described with respect to FIGS. 1-2B.

In embodiments, the orchestration engine 392 of the workflow manager can provide design, automation, and optimization of workflows across humans, APIs, and AI. In embodiments, the orchestration engine 392 can be “headless” (i.e., decoupled from UI) and can concurrently support multiple UIs. The orchestration engine 392 can further be a software system that defines, manages, and cues workflows or business processes.

The orchestration engine 392 can include a flow engine 310 to orchestrate the overall progression and state machine management of workflows. Flow engine 310 can perform task management, or coordinate the execution of tasks and decision points in a workflow according to dependencies and workflow logic. Flow engine 310 can further manage queuing and dispatching of tasks. For instance, engine 310 can be capable to deploy workflow definitions, start/stop instances, reassign tasks, etc. Additionally, engine 310 can maintain a persistent state of workflow instances to track where they are in the process. This can allow pausing and resuming during workflow executions by the orchestration engine 392.

A service log 320 can capture every action and state change, ensuring workflows can resume from any point. In embodiments, the log 320 can be used to track a history of all workflows, versions, tasks, decisions, and actions. Log 320 can further store data to enable user review and auditing.

Orchestration engine 392 can further include or access a monitor 330 to enable workflow monitoring. Workflow monitoring can give oversight into the operational health and performance of workflows. Monitor 330 can include or access tools for monitoring running and completed workflows, ensuring operators can promptly detect, respond, and resolve any issues within a running workflow. Accordingly, monitor 330 can provide monitoring capabilities like dashboards, alerts, SLA tracking, etc. to users for overseeing workflow executions.

Orchestration engine 392 can further include or access scheduler 340. Scheduler 340 may manage when and how tasks are executed. In embodiments, scheduler 340 can ensure workflows run at the right times and in the correct order.

Orchestration engine 392 can further include or access one or more triggers 350. Triggers 350 may be or include events that are tracked (e.g., a “property created” event, or a “tenant move-out initiated” event, etc.). These events can be used to execute tasks and workflows upon the detected occurrence of the event.

Orchestration engine 392 can further include or access an interface 360 (e.g., API integration) for communicating with internal and/or external modules and platforms of the system. In embodiments, interface 360 may be or include interface modules 199, as seen and described with respect to FIG. 1. In embodiments, interface 360 can be an API gateway that allows external systems and clients to interact with the workflow manager and/or orchestration engine 392. Such an interface 360 can further provide integration capabilities to invoke services, scripts, applications, etc. to implement workflow tasks.

In addition to providing a runtime environment, the orchestration engine 392 can provide an external metadata configuration format. In embodiments, engine 392 can be or include an off-the-shelf open-source or commercial orchestration engine.

FIG. 4 illustrates example deployment and execution process for deploying and executing a workflow via workflow manager 190 of FIG. 1, in accordance with embodiments of the present disclosure, while individual steps of the workflow may be executed by traditional software, humans, or LLM agent 124. Components, processes, and features as seen and described with respect to FIG. 4 may correspond, or be similar, to similar components as seen and described with respect to FIGS. 1-3. Thus, embodiments discussed with respect to FIG. 4, may incorporate and augment at least the embodiments described with respect to FIGS. 1-3.

The workflow execution process 400 can include workflow deployment 4.1, and execution 4.2.

At operation 4.1 of process 400, PMSS platform 170 can deploy a workflow 404 generated by workflow manager 190 in connection with an input prompt 402 provided to LLM agent 124. In one embodiment, LLM agent 124 is part of a hierarchy of one or more top level agents, each potentially having a number (n) of corresponding sub-agents. For example, in the embodiment illustrated in FIG. 4, LLM agent 124 can have corresponding sub-agents, 424, 1, 424.2, and 424.n. Each of the sub-agents may include a separate instance of the agent configured to perform a dedicated tasks associated with property management operations. Upon receiving input prompt 402 from PMSS platform, LLM agent 124 can perform execution 4.2 of the deployed workflow to analyze the input prompt 402, identify one or more tasks to be performed, and forward requests to the appropriate sub-agents based on the tasks.

In embodiments, the input prompt 402 generated and provided by PMSS platform 170 is guided by workflow 404. For example, a business logic component of PMSS platform 170 may receive a request from a user or other connected system, and may determine an action or task related to property management that is to be performed. In response, PMSS platform 170 may request a previously defined workflow corresponding to that action or task from workflow manager 190. In another embodiment, PMSS platform 170 may have previously received and stored one or more workflows 404 from workflow manager 190 that are available for use. As described above the workflow 404 includes a series of steps which can be performed to execute repetitive tasks in order to accomplish a specific goal. The workflow 404 serves as a guide for creating the input prompt 402 to provide to LLM agent 124 to ensure that the LLM agent 124 operates autonomously, but still in a permissible and expected manner, in order to achieve the goal. As described in more detail below, workflow 404 can be defined for any number of relevant tasks.

One example is a bill approval workflow. The receipt of a bill by PMSS platform 170 triggers the corresponding bill approval workflow (i.e., an event based trigger). A conditional branch of the workflow checks whether the property is over budget. If not, the bill may be paid automatically. If so, however, a rule engine determines from whom approval to pay the bill is needed. The workflow creates approval tasks, and once approved by all approvers the bill can be paid.

Another example is a delinquency workflow. The occurrence of an overdue payment from a tenant may trigger the delinquency workflow (i.e., an event based trigger). The workflow may send reminder to the resident, send a reminder with a late fee, and await a response (i.e., either payment or a message). If a payment in full is received, the workflow ends. If a message is received, the message can be provided to LLM agent 124 for interpretation. Depending on the interpretation of the message, the workflow can include a number of different response options, such as drafting and posting a delinquency note, offering a payment plan, or escalating to the property manager for review. In this example, state transitions in the workflow are driven via traditional automation once all criteria have been met, and the LLM agent 124 only acts within very tight constraints specified by the workflow.

An even more complex example is a workflow for scheduling a time for maintenance work. When using this workflow, the LLM agent 124 has a high level goal specified in input prompt 402, and access to a number (m) of associated tools, such as tools 426.1, 426.m. These tools can include any service or skill, such as, for example, a calendar tool for a maintenance service provider, or an interface for communicating with a resident. The LLM agent 124, or any of the corresponding sub-agents, can engage in a back and forth conversation to match up preferences and availability. At the end of the negotiation the LLM agent 124 creates a new calendar entry for the maintenance technician and confirms the time with the resident. The workflow is then advanced to a scheduled state. From there, the workflow branches depending on what happens next. If the maintenance work is carried out as planned, the workflow sends feedback request to the resident, the vendor sends a bill, and the bill approval workflow is carried out. If the resident cancels the service appointment (i.e., a workflow interrupt), the LLM agent 124 interprets the response, removes the appointment from the calendar, and asks resident if they want to reschedule. If yes, the workflow transitions back into the scheduling state, and if not, the workflow ends. If the vendor cancels the service appointment, the LLM agent 124 tells the resident to inform them of the cancellation, and asks resident if they want to reschedule. Some other business logic may be implemented to prevent infinite loops or trigger an escalation. In this case the LLM agent 124 gathers information from the resident and provides information by interacting with an external tool (e.g., calendar) to reach a scheduling goal. It also interprets external communication to induce state transitions.

While the workflows described above may be created and tested by PMSS platform developers, certain users may want to create and train a fully custom agent for a specific custom workflow. In such an embodiment, the user can provide the LLM agent 124 a high level description of the task (e.g. in the form of a custom workflow and description) as input prompt 402, and indication of one or more configurable tools (e.g. available API endpoints it can choose from), demonstrations, and continuous feedback. Whenever the agent is unsure how to proceed it will ask for clarification, get a new demonstration, and incorporate it into its knowledge base. LLM pipelines can be abstracted as text transformation graphs, where LLMs are invoked through declarative modules. Modules are parameterized, meaning they can learn (e.g., by creating and collecting demonstrations) how to apply compositions of prompting, finetuning, augmentation, and reasoning techniques. One difference from traditional ML methods is that “retraining” is very fast and cheap, and only requires a handful of demonstrations. Depending on the size of the dataset an optimization run takes on the order of seconds to a few minutes and doesn't require specialized hardware, costly storage, or hosting of custom models-it just optimizes the prompt via LLM calls. This means an agent set up in this way could “learn” almost in real time and be customized in principle for any task.

FIG. 5 illustrates example support processes for responding to a user query made within the system of FIG. 1, in accordance with embodiments of the present disclosure.

As illustrated by FIG. 5, in some embodiments, a user query can flow through process 500 in order to be routed to an appropriate support module. Process 500 can include a chat module 580, an AI model 522, one or more support modules 554, an interface module 556, and a storage platform 560 and external modules 564. In some embodiments, chat module 580 can correspond, or be similar to chat module 180 as was seen and described with respect to FIG. 1, and incorporate and/or augment at least the embodiments described therein. Components, processes, and features as seen and described with respect to FIG. 5 may correspond, or be similar, to similar components as seen and described with respect to FIGS. 1-4. Thus, embodiments discussed with respect to FIG. 5, may incorporate and augment at least the embodiments described with respect to FIGS. 1-4.

The process can begin by receiving a user query 502A at chat module 580 (e.g., through use of a client device and an input feature, as described with respect to FIG. 1). User query 202A can be any user query from a user 502. For example, a user of the PMSS as described herein can input a textual query into the input feature of a UI that is presented to them. Such a query can include a user request 502B, and an indicated intent 502C. In some embodiments, the indicated intent and user request of the query can be explicit, suggested, or implicit. For example, a user can explicitly state, “show me all records of defaulting or delinquent tenants with respect to property units x, y, and z.” The request of such a query can be to view such records, the intent can be to access and view such records. In a more suggested, or implicit form, a similar query can be phrased, “Can you help me remember how often units x, y, and z have had delinquent or defaulting tenants?” Although the user is not explicitly requesting the records for defaulted tenants, such a request can still be recognized by the module. In such a case, the request can be to view or receive the statistics of how frequently units x, y, and z, have had delinquent tenants. The intent can still be to access the records associated with delinquent or defaulting tenants. In such a way, a query can contain both an intent, and a request.

In embodiments, a user of the system can chain together tools (e.g., one or more support modules) via a single query to accomplish one or more tasks. For instance, finding tenants at a property could be followed by a bulk action, such as sending one or more tenants a message (e.g., via email). In embodiments, such a combined task can first retrieve tenant data (e.g., email addresses), and then utilize the retrieved data to populate the recipients of the message, and personalize each message with data pertaining to their associated records (e.g., an outstanding balance).

In embodiments, such one or more tasks can be associated and/or requested implicitly via a single query. For example, a query such as: “send tenants at property X a note that elevator maintenance is scheduled tomorrow,” can implicitly include a data query (e.g., “get tenants at property X”), followed by a message compose action (“send a message that . . . ”).

One of ordinary skill in the art, having the benefit of this disclosure, will appreciate that a user query can span many requests and intents associated with a PMSS, including, but not limited to, a request to summarize a document, a request to provide instructions, a request to send a communication to a resident (e.g., an email, text, etc.), a request to draft a document (e.g., a request to draft text, format a document, etc.), a request to provide a report including data associated with the PMSS, a request to generate a marketing description, a request to present a document, a request to generate a response to one or more questions (e.g., to generate a response about product usage), a request to retrieve data (e.g., to find or build a report), a request to produce code, or any other type of request, combination or requests, and/or sequences of requests associated with a PMSS.

As will be further described with respect to FIGS. 3A-B, chat module 580 can receive, process, augment, validate, and/or route user query 502A. In some embodiments, chat module 580 can process user query 502A to recognize the query request and intent. Based on such an intent, the module can route the query as query 504A to one or more appropriate support modules. In some embodiments, support module 554 can include several specific support modules 554A-G for routing a query to. In some embodiments, a specific support module 554A-G (or more than one) to which chat module 580 can route a query, can be chosen based on the exact query intent. In some embodiments, the chat module can store and/or recognize queries with similar requests and/or intents, so as to more rapidly route the query.

In some embodiments, if the request is underspecified or ambiguous the chat module can engage (with aid from AI model 522) in a conversation with the user to clarify or obtain missing information. In some embodiments, the chat module 580 can route a query to a support module, and then receive a communication from the support module that the query is underspecified or ambiguous, and proceed in a similar manner to clarify or obtain information. In embodiments this can be accomplished via a visual element of the UI (e.g., such as a chat box or search box). In some embodiments, chat module 580 and support modules 554A-G can leverage an AI model 522, to engage in such a conversation.

As mentioned above, support modules 554 can include specific support modules 554, to perform more specific, or focused support operation. A detailed description of each will be provided below. As a whole, support modules 554 (e.g., including any specific support module 554A-G) and/or chat module 580 can leverage interface modules 556, including data interface manager (DIM) 556A, and one or more API modules (e.g., API module 556B) for accessing and retrieving data associated with a storage platform 560 and database (e.g., a data store), or accessing and performing support operation (e.g., tasks) associated with modules external (or internal) to the system (e.g., external modules 564).

In some embodiments, for example, a support module can leverage API module 556B, which can index and present available APIs, including natural language descriptions of their scope, parameters, and response format, to generate a properly structured API request. In some embodiments, support modules can leverage the interface modules 556 and the AI model 522 to create such a communication. Such a process will be further described with respect to FIG. 6B, suffice to say now, that API module 556B and DIM 556A can be used by any support module to generate a structured API request that can be directly consumed by external (or internal) software systems and/or modules to perform a task. In some embodiments, a support module can generate the API communication and present it to the user for confirmation or modification. In other embodiments, a support module can directly execute the API communication sans user confirmation. As will be further discussed with respect to FIG. 6B, DIM 556A can function in a similar manner to form a structured communication for a storage platform or database.

A short description of the support modules 554A-G will now be provided. One of ordinary skill in the art, having the benefit of this disclosure, will appreciate that such a list of support modules is not exhaustive, and that in certain embodiments, further support modules can be incorporated within support modules 554.

In some embodiments, the support modules can include a text2data support module 554C. In some embodiments, text2data support module 554C can receive a routed query from chat module 580 when the chat module has determined that the query intent is to access a database. In embodiments, the text2data support module can be capable of mapping a natural language query into a formal query language. This can be useful for requests e.g., such as “show me tenants at property X with outstanding balance of more than $500.” Such a process will be further described with respect to FIG. 6B.

In some embodiments, the support modules can include a text generation support module 554A. In some embodiments, text generation support module 554A can receive a routed query from chat module 580 when the chat module has determined that the query intent is to generate text from a user prompt within the query. Such instances can include when chat module 580 has identified that a request intends to create a draft email, a draft passage of text, or a draft summary of a document, etc. In some embodiments, the text generation support module 554A can leverage the AI model 522, which can be a generative AI model such as an LLM or similar, to generate natural language text for a user. In some embodiments, the text generation support module 554A can generate text including provided data. For instance, in some embodiments, the text generation support module 554A can generate text having pre-filled recipients from a previous data query, or generate text containing placeholders to personalize messages (including data fields, such as an outstanding balance). In some embodiments the text generation support module 554A can generate text that has been translated from a first language to as second language (e.g., into the recipients' preferred language(s)). In some embodiments, the text generation support module 554A can send messages via recipients preferred communication method (email, SMS, WhatsApp, etc.). In some embodiments the sending of a communication can be accomplished via the text2Action module 554D, or via an external module.

In some embodiments, the support modules can include a marketing description support module 554B. In some embodiments, marketing description support module 554B can receive a routed query from chat module 580 when chat module has determined that the query intent is to create a marketing description for a particular property, or similar element (e.g., a home or rental unit). In furtherance of such an objective, module 554B can access data and characteristics associated with an identified property stored within the system, such that a user can not have to input all such information associated with a property. Such information can include, by way of example, square footage, location, amenities, property characteristics, etc. In some embodiments, module 554B can provide such information, along with the user query and other information, to AI model 522, which can be a generative model, to arrange, format, and expand on the information to create a proper response to the user query.

In some embodiments, the support modules can include a text2action support module 554D. In some embodiments, text2action support module 554D can receive a routed query from chat module 380 when the chat module has determined that the query intent is to perform an action associated with a PMSS. Such actions can include, sending an email, preparing a contract, assigning a vendor to a work order, adding a note or reminder to a work order, marking a work order as complete or incomplete, etc. In such cases, the smart action module 554D can leverage API module 556B, and AI model 522 (which can be an LLM) to interpret whether such an action is feasible given the available APIs. In some embodiments, if such an action is feasible, module 554D can form and format the API communication, and transmit it to a corresponding software module and/or database. In other embodiments, module 554D can be outfitted to accomplish the requested action independently.

In some embodiments, the support modules can include a report filtering support module 554E. In some embodiments, report filtering support module 554E can receive a routed query from chat module 580 when chat module has determined that the query intent is to request a type of report. In some embodiments, support module 554E can form a database query to gather data for the report, by leveraging DIM 556A, the AI model, and the user query. Support module 554E can then execute the database query, and access and retrieve the specified data (e.g., from storage platform 560 and any associated databases) necessary to create a report. For example, should module 580 identify that the user query would like to access “x” data, module 554E can communicate with DIM 556A to form a formal database query for accessing “x” data from the corresponding datastore and/or storage platform. Module 554E can then execute the query (or cause DIM 556A to execute that query) against a database. After such, module 554E can perform more processing on the data (e.g., in some cases leveraging modules of query processing platform, in some cases leveraging models of the AI model platform) to manipulate the data into an acceptable format for transmitting the data indicated by the user query back to chat module 580.

In some embodiments, a requested report can be prebuilt, and simply retrieved via the report filtering support module 554E (or a separate support module). In some embodiments, the report filtering support module 554E can modify, or “prune,” a prebuilt report that has been retrieved. E.g., report filtering support module 554E can apply filters, include specific columns, etc.

In some embodiments, the support modules can include a QA bot support module 554F. In some embodiments, QA bot support module 554F can receive a routed query from chat module 580 when the chat module has determined that the query intent is to receive an answer to a question associated with operating the PMSS. In some embodiments, this is accomplished by providing resources, such as product specific help articles and documentation, either as context with instructions or via another fine-tuning step involving known question and answer pairs. In some embodiments, these are then turned into a natural language summary of the required steps (via aid of the AI model 522), and include citations of specific sources based on the provided context such that a user can verify the information. In some embodiments, module 554F can perform the final formatting of the response to the user, in others, module 554F can simply provide the information to chat module 580, which can then accomplish the final formatting. In some embodiments, the chat module 580 can directly route a user to a relevant page, or offer to execute an action on behalf of the user, rather than simply provide information or summaries.

In some embodiments, the support modules can include a human support module 554G. In some embodiments, human support module 554G can receive a routed query from chat module 580 when the chat module has determined that the query intent is such that it cannot be processed by any other support module of the system. In some embodiments, such a query can be delivered into a queue, to await a human response. In some embodiments, the module can facilitate a human response, such as a text (e.g., an instruction, clarifying question, etc.).

In some embodiments, any of the above support modules can return a response 504D after an operation has been executed by the support module. As discussed above, in some embodiments, the response can be a confirmation that an action has been completed, a request for more information, data retrieved from a database, or a textual response to the user query. In some embodiments, as previously mentioned, the chat module 580 can divide a user query into one or more subqueries to multiple tools (e.g., support modules of support modules 554), and combine the results.

Thus, in some embodiments, support modules 554 can include several support modules 554A-G, for performing support tasks associated with a user query.

FIG. 6A illustrates an example process for routing a user query made within the system of FIG. 1 to a support module, in accordance with embodiments of the present disclosure.

Process 600A of FIG. 6A can include an input feature 616 of a client device, a user query 602A, a semantic analysis module 632, a validation module 634, a chat module 680, one or more support modules 654 and interface modules 656, of a support platform 650, a filtering module 636, and one or more AI model(s) 622. Components, processes, and features as seen and described with respect to FIG. 6A may correspond, or be similar, to similar components as seen and described with respect to FIGS. 1-5. Thus, embodiments discussed with respect to FIG. 6A, may incorporate and augment at least the embodiments described with respect to FIGS. 1-5.

As illustrated by FIG. 6A, in some embodiments, the flow of a query through process 600A for processing a user query can begin at operation 6.1 (i.e., query collection 6.1). At operation 6.1, process 600A can receive a user query 602A through an input feature 616 of the system.

Input feature 616 (which can correspond to input feature 116 of FIG. 1) can be any feature capable of intaking text data from a user, including, but not limited to, a chat box, a query feature, a chat box including speech to text capabilities, etc. In embodiments, the input feature can accept any form or type of input data relevant to a PMSS, including audio, image, video, text data, etc. E.g., in embodiments, a user can upload an image such as an image of an invoice to be processed and responded to by the system. One of ordinary skill in the art, having the benefit of this disclosure, will be able to implement different versions of input feature 616, while still maintaining the functionality of transferring a user query from a client device to a PMSS platform.

In some embodiments (as was described with respect to query 502A in FIG. 5), a user query 602A can be a natural language user request for an action or data. E.g., a user query can be, a request for an explanation, a request for a report, or any natural language prompt associated with PMSS.

In some embodiments, following collection 6.1, the process 600A can route a user query at operation 6.2, by performing semantic analysis 6.2A and validation 6.2B. In some embodiments, a chat module 680 of the system can leverage, direct, or otherwise cause routing 6.2 to be performed. In some embodiments, such a chat module can distribute the user query 602A to semantic analysis module 632, and collect the routed query 604A from validation module 634. In other embodiments, the chat module itself can form the functions of operation 6.2. In some embodiments, validation 6.2B can precede semantic analysis 6.2A, or occur in parallel.

In some embodiments, semantic analysis module 632 can perform semantic analysis to interpret a user query, identify its associated request and intention. In some embodiments, semantic analysis module 632 can leverage a LLM associated with the system (e.g., any of the AI models and/or LLMs described with respect to current disclosure) to aid in performing semantic analysis.

In some embodiments, the semantic analysis module can preprocess the user query using a variety of known NLP methods and techniques so as to extract the intention and request associated with a query. Such methods and techniques can include, tokenization, part-of-speech tagging, categorization according to semantic structure, and/or named entity recognition (NER) (e.g., to extract names, organizations, locations, and other categorical information), and other such or similar techniques. In some embodiments, semantic analysis module 632 can perform NER, in other embodiments, semantic analysis module 632 can leverage a dedicated NER software platform or service.

Entity recognition (e.g., NER) can be performed by module 632 to extract entities, e.g., a term associated with text, such as an object, place, or concept, etc., from a user query. To begin with, entity recognition can tokenize the query, thereby segmenting the query into tokens representing individual words, or similar structures within the query. Following tokenization, the entity recognition module can perform part-of-speech tagging, via its semantic role (e.g., identifying each token as a noun, verb, adjective, etc.).

After such processes, the semantic analysis module can apply entity extraction. This step can use the tagging and a NER subsystem of the semantic analysis module such as a trained machine learning model, to identify which tokens or groups of tokens constitute potential, or candidate, entities.

In some embodiments, the NER subsystem can be, or use, one or more of a dictionary-based approach, a rules-based approach, a machine learning approach, a transfer learning approach (such as fine-tuning an off-the-shelf LLM for NER), or a LLM (e.g., an LLM based on transformer architecture, such as bidirectional encoder representations from transformers (BERT), ROBERTa, or the GPT series of LLMs, etc.), or any combination of such algorithms.

After candidate entities have been extracted from the user query and categorized via the above processes, such candidate entities can be verified via a search engine. For example, in some embodiments, the candidate entities are used as search queries for the search engine where the search is narrowed via the entity category. Retrieval of relevant and logical results can corroborate their status as actual entities, as well as correct typos, resolve ambiguities, or return an internal identifier of the entity that can be used to filter queries in the text2data module. Such results can also aid in rendering a search field for the user to resolve ambiguities (e.g., in the simple case where multiple tenants share a same name, the results can be provided to a user to select the target tenant). Such a process can involve searching for the potential entity in the title, abstract, or body of the returned search results. In the absence of such corroborative information, a candidate entity might be flagged for further investigation, or classified as a non-entity based on certain thresholds or criteria. Semantic analysis module 632 can include a search engine, or can query an external, existing one.

Thus, entities associated with a user query, and processes such as entity recognition (NER), can be performed by the semantic analysis module 632. Such a process can be in furtherance of recognizing the intent, request, and/or meaning behind such a user query. After such a process, semantic analysis module 632 can transfer the produced semantic analysis data (e.g., entities, intent, request, etc.), back to chat module 680, or otherwise directly transfer the data as augmented query 602D to validation module 634.

One of ordinary skill in the art, having the benefit of this disclosure, will appreciate that NER and entity extraction in general is a rapidly developing field of natural language process (NLP), and appreciate that the above list of NLP algorithms and techniques is non-exhaustive. Such a list can be updated to include further NLP algorithms for performing NER.

One of ordinary skill in the art, will recognize that there are many methods (NLP-associated and otherwise) that can be used to interpret the intention and request of a natural language user request, and that the above list of methods and techniques is non-exhaustive. One of ordinary skill in the art, will appreciate that such an area of NLP is a rapidly developing area of research, and that the above list can be updated and expanded to include further NLP methods and techniques as they become available.

Once the intent and request associated with a query have been recognized and understood, the chat module can determine which support module of modules 654 to route the query to. Chat module 680 can use the intent, request, and extracted semantics data, together with a routing approach such as rules-based approach such as key-word matching, a neural network classifier, a LLM, or any other common query routing technique to determine a destination support module to which to route a user query.

In some embodiments, if insufficient information is available within the query to identify an intent and request, chat module 680 can leverage a LLM to generate a response requesting further information. In such a way, the process can be repeated until a user intent and request can be identified.

In some embodiments, the query can be augmented by the chat module 680 (or by the semantic analysis module) with the extracted semantics data, or with any other kind of data relevant to the query, meaning that additional information (e.g., such as an identified query intent and request) can be attached to the query as it is transmitted for further processing. In such a way, entity recognition and semantic processing need not be performed again, or duplicated by downstream processes. In some embodiments, the query can be augmented with any data available to the chat module 680 (or any data available to the system at large), such as user specific data, including contextual information regarding the page the user is currently visiting.

In some embodiments, before and/or after the query has been analyzed, the query can be compared against one or more previously processed queries. In embodiments, comparing against previously processed queries can aid in analysis and routing. E.g., a query can be processed to identify a level of similarity with a previously made query, and can be similarly routed. Such a process can enhance routing, speed up processing, and decrease computational time and resource-usage.

In some embodiments, at operation 6.2B, the process can validate an augmented query 602D from chat module 680. Validation module 634, can affect processes that ensure the integrity and appropriateness of a user query before further processing.

For example, at operation 6.2B, module 634 can conduct several verification processes of the user query, including, but not limited to verification processes associated with syntactic correctness (e.g., in format, structure, length, punctuation, completeness, etc.) permissions verification (e.g. verifying a user's role, access level, etc. to view or access data indicated by the request), content monitoring (e.g., screening for phrases, words, or patterns that can be inappropriate, offensive, or in violation of guidelines, rules, and/or policies of the PMSS), etc.

Such validation processes can include, but are not limited to, similar processing techniques as described in operation 6.2A (and can leverage the attached semantic data of the augmented query) including, but not limited to, filtering techniques, tokenization, tokenization, part-of-speech tagging, categorization according to semantic structure, NER, keyword matching, or comparison to keyword lists, etc. One of ordinary skill in the art will appreciate that many similar methods can be included, and that the above list is non-exhaustive.

By executing such verification processes, the validation module 634 ensures that query 602D is valid, appropriate, and compliant with the system's rules and guidelines prior to further processing. As was described above, such a validation process can be conducted prior, in tandem with, or after semantic analysis, and intent recognition from semantic analysis module 632.

In some embodiments, validation module 634 can pause the process and routing of the query, if such a query is deemed to be invalid, surpass the user's access permissions, or otherwise violate a policy of the system.

As mentioned above, in addition to validating, the validation module can further augment query 602D (e.g., such that routed query 604A is augmented with additional data). In such a way, chat module 680 and/or validation module 634 can attach semantic, validation, or other useful data to the user query. Such data can be of the form of entity identifiers, types, and metadata of extracted entities. Such data can serve to provide deeper contextual insights into the query, request, and intent that can be useful in downstream processes. For instance, if an extracted entity is a known person, such data might be attached to the query, along with identifiers like occupation, geographical location, or any other relevant metadata associated with the extracted entity. Such data can be used by downstream processes (e.g., support modules 654).

In addition to routing, semantic analysis, and validation, chat module 680 and/or validation module 634 can also anonymize the query. The anonymization process typically involves identifying and obscuring or replacing personally identifiable information (PII) within the query. For example, PII might have been identified during semantic analysis, and can include names, addresses, contact information, or any other information that could potentially identify an individual. Using anonymization algorithms, chat module 680 and/or validation module 634 can detect such information, and replace it with anonymized tokens or entirely remove it from the query, while leaving the overall content and intent unaltered.

Thus, through a combination of semantic analysis that can include LLM integration, and/or entity recognition techniques, chat module 680 can generate, or direct to be generated, a representation of the query's intent and request. Based on such a representation, a decision can be made regarding the most suitable routing flow path for the query. As was discussed above, in some embodiments, such a decision for routing can be made based on a series of predefined rules or algorithms (e.g., a rules-based algorithm using keyword matching). In some instances, other sorts of decision-making algorithms (which can include the use of machine-learning models including large language models, deep learning models, neural networks, convolutional neural networks, etc.) can be used to identify the most relevant destination for the query.

At the outset of the above processes, a validated query (e.g., routed query 604A, which is augmented and validated) can be routed to a support module of support modules 654 of platform 650 (as were discussed with respect to modules 554 and platform 550 of FIG. 5). As was described above, such support modules can complete a support operation or task and/or provide a response, gather data that will enable module 680 to generate a response, or otherwise facilitate operations associated with the routed query. Such support operations and processes (e.g., support operations 5.3 and 5.4) were discussed with respect to FIG. 5, and will be further discussed with respect to FIG. 6B. Suffice to say, in many such support operations, a database can need to be accessed by the support module platform, or an external (or internal) API can need to be invoked.

After such processes are performed, in some embodiments, the support modules and support platform can output a communication (e.g., in the form of executed query 604D) that can be returned to chat module 680, which can then leverage a filtering module and an AI model for filtering and response generation (at operation 6.5). In other embodiments, the support platform 650 can transfer executed query 604D directly to filtering module for filtering.

In some embodiments, executed query 604D can be the same query as routed query, with further augmentations e.g., such as further augmentations that include data retrieved from a database. In other embodiments, the query can be augmented with an indication that a request within the query has been executed, or a similar augmentation.

Prior to transmission of the user query, and any attached data, to the AI model 622, and back to a user, a filtering model 636, can perform filtering of the query and its augmentations to ensure appropriateness and formatting as required by an AI model 622 for response generation (e.g., at operation 6.5A).

By way of example, in some embodiments, inputs to the AI model 622 can have a maximum length constraint, and in some cases, executed query 604D, together with any augmentations from processing can surpass such a maximum length constraint. In such cases, filtering can shorten an executed query to produce a filtered query, prior to processing by AI model 622.

After filtering, the AI model 622 can form a response to the user query to send to the user (at operation 6.5B), based on executed query and any augmentations that such a query can have.

For example, in some embodiments, if a query (including a request and intent) has requested a report on data from a database associated with the PMSS, executed query 604D can be augmented with such report data from processes 6.3 and/or 6.4. AI 622 can then receive both the query, and query augmentations, and format a response to the query in natural language. In more specific examples, a user of the PMSS can provide a query requesting a report of all the expenses associated with a business unit, or rental unit associated with a RE owner, or a user query can request guidance or instructions for example on the sequence of tasks necessary to provide an eviction notice to a renter of a rental unit. In both such cases, the PMSS can need to access a database, and stored records, or instructional documentation to provide an adequate response. Such records and documentation can be similarly attached to the query as augmentation data by processes 6.3 and/or 6.4, and transmitted to AI model 622 at operation 6.5B.

In some embodiments, the AI model 622 can correlate the query (including semantic data) and augmentation data, and align the semantics of the query with the context provided by the data. This can involve mapping the entities, actions, or conditions identified in the user query to corresponding elements (e.g., column names, data types, records, etc.) within the augmentation data. Based on such correlational understanding, the AI model can generate a response to the user query. In some embodiments, such a response could be a factual answer, a summary of relevant data, or a more complex analysis or prediction based on the data. Such a response can then be formulated in natural language, making it easily comprehensible to the user.

Thus, AI model 622 can process, understand, and respond to the user query within the context of the retrieved data, and thus provide useful responses based on such data. Thus, in some embodiments, the retrieved data, attached to the query as an augmentation, can be sourced from the storage platform can provide the content or context for answering or addressing the user query.

In some embodiments, the AI model 622 can form a response 602E to the user query 602A, where no data retrieval has been performed, or only a task, or support operation has been performed. In such cases, executed query 604D may or may not be augmented with retrieved data, but can be augmented with a confirmation that such a task (e.g., a support operation) has been performed. The AI model 622 can similarly generate a response to the user query, leveraging known data and prior training, and the confirmation found in the query augmentation.

FIG. 6B illustrates an example process for performing support operations within the system of FIG. 1, in accordance with embodiments of the present disclosure. The elements, numberings, and descriptions of FIG. 6A are incorporated herein.

In some embodiments, the support modules 654 can leverage interface modules 656 to perform support operations (tasks) based on a routed query 604A, and output an executed query 604D (as were described in FIG. 6A).

In some embodiments, a query can include a request that requires data retrieval (operation 6.3) from a database. To properly retrieve data from a database (e.g., such as a database within data stores 160A or 160B of FIG. 1) the support module platform, or DIM 656A, can need to perform database mapping (seen at operation 6.3A), query formalizing (seen at operation 6.3B) and data retrieval (seen at operation 6.3C). In some embodiments, such operations can be facilitated and/or performed by support modules 654 and/or DIM 656A. In some embodiments, more than one data retrieval can need to be accomplished for a routed query, by one or more support modules.

In some embodiments, database mapping 6.3 can intake a routed user query (e.g., routed query 604A) and attached augmentation data 604B (e.g., semantic and/or validation data) that has been attached or augmented to the user query. Such a process can produce mappings 606B, or database structures that correspond to the entities and structures identified within the user query. Thus, in some embodiments, it is assumed that entity recognition and query augmenting (including all embodiments and details described in FIG. 6A) can have already been fully accomplished, and that routed query 604A includes augmentation data.

Accordingly, the DIM can leverage a database schema 606A, together with the query and entity data to produce mappings, or corresponding database entities associated with a database. In some embodiments, DIM 656A can produce mappings 606B by cross-referencing query and entity information with the database schema 606A.

In some embodiments, such a schema 606A can act as a map, or look-up table, corresponding to the database, outlining its organization and content. Such a schema can include details of the structure of the database, including table names, table definitions, field types, column names, relationships, indices, keys, and any constraints, etc. associated with an associated database.

DIM 656A can therefore align the semantics of the user query with the specific language and structure of the database. For example, if a query specifies a database request along the lines of “show me the names and ages of all renters who are late on rent for the current month,” the extracted entities can include “renters, delinquency status (and/or period), date range.” DIM 656A might intake such a query and augmentation (e.g., entity) data, and identify corresponding data fields such as “renters.first_name, renters.last_name, renters.age, renters.delinquency_status . . . ,” and so on. Such mappings can be output as mappings 606B, or otherwise be attached to the query, as further augmenting or augmentation data.

The DIM can then leverage an AI model 622 to formalize the query, and retrieve data from a data store, as seen in operation 6.3C by executing the formal query against a database and/or associated storage platform. As previously mentioned, in some embodiments, the mappings or the formal query can be stored, together with the user query and any query augmentation data to facilitate rapid processing for similar user queries that can be received in the future.

In some embodiments, the AI model 622 can intake the user query (e.g. routed query 604A) and mappings 606B, and formalizes the query, i.e., create a structured query in the appropriate language, that adheres to the syntax and conventions of the database associated with the database schema. In other words, AI model 622 can translate the query from natural language to the database language. The result is a formalized user query (e.g., formal query 604C) that is ready to be run against the target database.

At operation 6.3C, the DIM (or an associated support module) can then transfer the query to the appropriate database, and receive the requested data 606C. The transmission of a formal user query to a storage platform 660 and associated data stores and databases, to retrieve data 606C can be facilitated by a database control module (e.g. that can be similar, analogous, or part of platform control module 162 as seen in FIG. 1) equipped to receive the query and perform data extraction. In embodiments, the storage platform 660 can further authenticate and authorize a requesting user to ensure that the user is authorized to access queried data.

Such processes can involve technologies such as JDBC for Java platforms or ODBC for lower level programming languages like C or C++. These protocols provide a standardized API for database queries and operations, and ensure secure and reliable data transmission between the DIM and the storage platform 660. Once a connection is established, the DIM can transfer the formal query 604C to the storage platform 660. The storage platform can then execute the query against the database (e.g., a datastore), to retrieve the requested data. This retrieved data 606C could be in various forms, including vectorized, structured, or unstructured data, depending upon the nature of the query and the database schema. The storage platform 660 can then send the retrieved data back to the DIM over the established connection.

Finally, the DIM returns the received data back to support modules 654, which can further process the data, perform operations based on the data, or prepare a response for the user based on the data. In some embodiments, the received data 606C, can then be attached (through augmentation, in a similar method as described with respect to the entity data), or otherwise coupled with executed query 604D, and be sent to an AI module 622, and response generation at operation 6.5.

In some embodiments, operation execution 6.4 can proceed in a very similar manner, using similar or analogous modules to data retrieval 6.3, to execute a support operation or task (as was described with respect to FIG. 5). In some embodiments, more than one support operation can be completed. In some embodiments, the support operation can be accomplished before, after, or in tandem with, one or more data retrieval operations.

Such support operations, such as sending an email, or requesting a payment, as were discussed in FIG. 5, can need to be performed by external (or internal) modules. Thus, at operation 6.4, API module 656B can intake a routed user query (e.g. routed query 604A) and attached augmentation data 604B (e.g. semantic and/or validation data) that has been attached or augmented to the user query and can produce mappings 608B, or API structures that correspond to the entities and structures identified within the user query, that will be used to construct a communication to an API to accomplish a support operation.

Accordingly, the API module 656B can leverage an API schema 608A, together with the query and augmentation data to produce mappings, or corresponding API entities associated with an external module. In some embodiments, module 656B can produce mappings 608B by cross-referencing query and entity information with the API schema 608A.

In some embodiments, such a schema 608A can act as a map, or look-up table, corresponding to an external module API, outlining its organization and content. Such a schema can include details of the structure of the API, including possible operations, necessary fields and types, as well as expected outputs or any constraints, etc. associated with an external module. Many such API schemas can be housed within API module 656B, and interface module 656 in general.

Module 656B can therefore align the semantics of the user query with the specific language and structure of the API and capabilities of the external module. For example, if a query specifies a request along the lines of “send the following text X to email address Y,” the extracted entities can include “email address, message content, send.” Module 656B might intake such a query and augmentation (e.g., entity) data, and identify corresponding data fields such as “address.send, message.content., and task.send . . . ,” and so on. Such mappings can be output as mappings 608B, or otherwise be attached to the query, as further augmenting or augmentation data.

The system can then leverage an AI model 622 to formalize the query into an API call in a similar way that was described above with respect to operation 6.3B. Such an API call can accomplish a requested operation, and executes the formal query 604C (e.g., an API call) against an external module 664. Confirmation that an operation or task has been completed, together with any returned, or necessary data, can be returned to support modules 654 as confirmation 608C, and can be attached as augmentation data to executed query 604D.

Such processes can be similar to processes described with respect to data retrieval 6.3, and involve technologies such as JDBC for Java platforms or ODBC for lower level programming languages like C or C++. These protocols provide a standardized API for database queries and operations, and ensure secure and reliable data transmission between the interface module 656B and external module(s) 664.

Thus, the chat module 680, support modules 654, and the PMSS at large can analyze, validate, augment, execute, retrieve data associated with, perform support operations for, and generate responses to queries from a user of the PMSS.

FIG. 7 illustrates an example process for editing a workflow using the workflow manager and chat module of FIG. 1, in accordance with some embodiments of the present disclosure. Components, processes, and features as seen and described with respect to FIG. 7 may correspond, or be similar, to similar components as seen and described with respect to FIGS. 1-6B. Thus, embodiments discussed with respect to FIG. 7, may incorporate and augment at least the embodiments described with respect to FIGS. 1-6B.

As seen in FIG. 7, example process 700 for editing a workflow can include drawing an initial workflow 606 from a workflow repository 760, editing the workflow via a workflow editor 794 (at operation 7.2), and storing an edited workflow back into the workflow repository 760.

In embodiments, the initial workflow 706 to be edited can be drawn from a repository 760. E.g., in embodiments, initial workflow 706 may be a workflow that has already been generated. Alternatively, initial workflow 706 may be a workflow that is being generated e.g., through a workflow generation functionality of workflow editor 794 of the workflow manager and/or chat module 780. In some cases, the workflow editor 794 can include a chat interface for engaging with the chat module 780. This can be or include a chat box, a text-entry space, etc. Such editing functionality will be further described with respect to FIG. 9.

FIG. 8 illustrates an example workflow capable of being generated by the workflow manager and chat module of FIG. 1, in accordance with some embodiments of the present disclosure. Components, processes, and features as seen and described with respect to FIG. 8 may correspond, or be similar, to similar components as seen and described with respect to FIGS. 1-7. Thus, embodiments discussed with respect to FIG. 8, may incorporate and augment at least the embodiments described with respect to FIGS. 1-7.

As seen in FIG. 8, in embodiments, an example workflow 800 can include a first text step 802, an LLM agent 804, first and second flow paths 806 and 808, and a second text step 810.

In some cases, the first text step can be or include an action (e.g., a task) as defined by input from a user. Such input can be textual input. Such input can be provided to the workflow editor, or to the chat module (e.g., as described with respect to FIG. 7). In embodiments, when executed the orchestration engine can access the correct modules and functionalities (e.g., through interfaces and APIs of the engine) and execute the text step. For instance, in embodiments, text step 802 can include or be an action described by text, such as “find all the tenants in the property ‘Coronado Park’.” To execute such a task, the orchestration engine may leverage the API components (e.g., and/or the chat module) to form a request to access such data, query the correct database to access such data, and receive and store that data, prior to any other actions of the workflow 800. It should be noted that, in many cases, a workflow can be built using the workflow builder via a UI. Such a process may include the use of certain natural language commands to facilitate defining a trigger condition or action to be taken, but this is not required. In such cases, the text steps described herein may not be used.

LLM agent 804 can follow text step 802, and can represent a decision point for a user or intelligent agent (e.g., such as the LLM agent 804) to make a decision associated with the bifurcation to flow path 806 and 808. For instance, continuing with the previous example (in which text step 802 includes the text and/or task of finding all tenants in the property “Coronado Park”), the LLM agent 804 (or another intelligent agent) can be used to sift through data collected from text step 802 and determine if any tenants are delinquent or not. Should a tenant be determined as delinquent (e.g., based on payment data, current date and time data, and any other relevant information stored with respect to the tenant), the LLM agent can decide if a tenant is delinquent or not. In some embodiments, the determination of delinquency is based on a hard rule, however, the LLM agent 804 can assist with the process of handling a delinquent tenant. For example, the LLM agent 804 can interpret any communication from the tenant, negotiate a payment plan, suggest next steps, summarize the interaction, facilitate a next step by analyzing contextual data (e.g. has this tenant been delinquent before, have they been difficult in previous interactions, do they cause complaints from the neighbors etc.)

Based on such a determination, flow path's 806 and/or 808 may be selectively performed. For instance, in cases where a tenant is delinquent, text step 810 may be used to draft and send a delinquent email. As was described with respect to text step 802, such an action can be or include an action as described by text, e.g., “draft and send delinquent email.” During execution of such task(s), such task(s) can be performed by the orchestration engine of the workflow manager.

In cases where a tenant is determined to not be delinquent, the flow path 808 may be performed, and text step 810 may be foregone. After such a decision point and bifurcation, flow paths 806 and 808 may join (e.g., into flow path 812) and continue to further processes, tasks, and decision points of the workflow.

FIG. 9 illustrates an example user interface (UI) for the workflow editor of FIG. 5, in accordance with some embodiments of the present disclosure. Components, processes, and features as seen and described with respect to FIG. 9 may correspond, or be similar, to similar components as seen and described with respect to FIGS. 1-8. Thus, embodiments discussed with respect to FIG. 9, may incorporate and augment at least the embodiments described with respect to FIGS. 1-8.

In some embodiments, UI 900 of FIG. 9 can be provided to, and/or for presentation, at a client device (e.g., client device 110 of FIG. 1). As described with respect to FIG. 1, UI control module 174 can generate a UI such as UI 900 to enable users to input and receive data, instructions, queries, or any other kind of communication to or from any platform or module of the system. In embodiments, UI 900 can be a UI associated with the workflow manager of FIG. 1 (e.g., in embodiments UI 900 can illustrate a UI for a user to interface with the workflows editor). Thus, in embodiments, UI 900 can be used by a user for accessing, generating, modifying, editing, deploying, and storing a workflow associated with the PMSS.

In some embodiments, UI 900 can include an input feature 916. Input feature 916 can correspond, or can be similar, to input feature 116 as was described with respect to FIG. 1 and incorporate and/or augment at least the embodiments discussed therein.

As illustrated in FIG. 9, UI 900 can include one or more visual elements. As was discussed with respect to FIG. 1, a visual element can refer to a UI element that occupies a particular region in the UI. A UI can include a number of visual elements to display to a user and/or for user interaction. Such visual elements can include one or more windows (e.g. informational display windows which can display the documents, text, figures, or data streams associated with the PMSS), chat boxes (e.g. chat boxes for a user to input textual information), informational displays (such as participant lists, document viewers, etc.), as well as input elements (such as buttons, sliders, chat interfaces, spaces for text, audio, image, video, and other document uploads, etc. for a user to input data), or any other kind of visual element commonly associated with a UI.

Such visual elements can be arranged or divided into specific regions of the UI. For example, UI 900 can include a main region (e.g., main region 902) that is intended to be an area of focus of the UI. In some embodiments, such a region can include information, graphs, data, workflows (e.g., workflow 980) etc. for display for a user. Multiple subregions can hold other elements, such as further information, or program controls. For instance, subregion 904 below the main region 902 or subregion 920 which can include a chat feature associated with the PMSS. Thus, an example UI of the system can hold multiple regions.

The UI can also present to the user interactive elements like buttons and sliders for controlling various aspects of the display and/or UI elements. For instance, in some embodiments, subregion 904 can include multiple buttons for inputting commands to the PMSS for navigating, controlling a document viewer, accessing and/or editing a workflow, uploading and downloading content, etc. In embodiments, subregion 904 can include controls for accessing, generating, modifying, editing, deploying, and/or storing a workflow associated with the PMSS.

Via the UI, users can be shown a chat feature (e.g., seen in subregion 920) that can include a chat history of the user, either chatting with other users of the PMSS, or with the chat module (and further associated modules) of the PMSS. As seen in example UI 900, a chat history, including multiple comments 922A-C, can be displayed to a user of the system. The chat history can include accessible documents, data, and links that can be presented to a user of the system.

In embodiments, the chat feature seen in subregion 920 may access or leverage the chat module (e.g., chat module 180 as described with respect to FIG. 1) of the PMSS. As seen within comments 922A-C, the functionality of such a chat feature can be leveraged by the user to generate and/or edit a workflow. For example, comment 922A can be an example of a comment generated by a user, with the intent of generating a workflow in which delinquent tenants from a property are sent a reminder of a delinquent status. As seen in comment 922B, the chat module (e.g., through an intelligent agent such as an LLM), can respond with a request for further information. After receiving further information (e.g., through comment 922C), the chat module can communicate with the workflow manager, to display an example of the generated workflow (e.g., workflow 980) to a user of the system.

In some embodiments, the chat feature (and underlying chat module) can be used to separate one or more tasks, as entered by a user into constituent subtasks. In some cases, the chat module can generate textual descriptions for such subtasks. In some cases, the chat module can generate API-level instructions, or API calls, for accomplishing tasks. For instance, in embodiments, upon entry of a textual query requesting the generation of a workflow, the chat module may identify constituent subtasks and decision points for the workflow. The chat module may additionally identify data-types and inputs for those tasks and decision points. The chat module may also generate code or API-level operational instructions for executing tasks, gathering such data, and otherwise accomplishing the actions associated with the workflow. In embodiments, the workflow manager may store such outputs of the chat module along with the workflow definition.

In embodiments (alternatively, or in addition to, the controls seen in subregion 904), the chat feature in subregion 920 can be used to access, generate, modify, edit, deploy, and/or store a workflow associated with the PMSS. The chat feature can be used to add a task or a decision point, to remove a task or a decision point, to update, remove, or add flow paths connecting any tasks and decision points, and/or modify any tasks or decision points of a workflow.

In some embodiments, input feature 916 can be used to input textual data (e.g., a user query) meant for an associated chat module (as was described with respect to FIGS. 5-6B, and incorporating at least the embodiments described therein). In other embodiments, input feature 916 can include use of a microphone and a speech-to-text module, or of a machine generated textual suggestion for a user to select, or any other kind of user input that might be used for providing a query to the underlying chat module (e.g., such as a text, image, audio, and/or video upload function). Thus, a user engaging with the UI 900 can engage the underlying chat module, AI models, and support module modules by providing a user query to the PMSS via input feature 916.

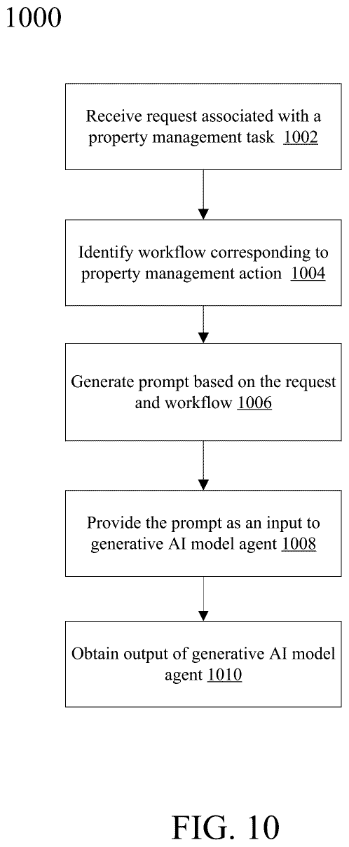

FIG. 10 illustrates an example process for executing an agent-driven workflow, in accordance with some embodiments of the present disclosure.

Method 1000 can be performed by processing logic that can include hardware (circuitry, dedicated logic, etc.), software (e.g., instructions run on a processing device), or a combination thereof. In one implementation, some, or all of the operations of method 1000 can be performed by one or more components of system 100 of FIG. 1.

At block 1002, the processing logic can receive a request. In one embodiment, PMSS platform 170 receives the request from a client device, such as client device 110, connected to the PMSS platform 170. The request can represent a triggering event and can be received in any variety of ways, such as via an API, text, email, voice, in-app chat, etc. In one embodiment, the request is associated with a property management task. For example, the property management task can include generating listings for RE units, handling delinquencies, reconciling bank accounts, renewing leases, managing maintenance work orders, generating reports, etc. Depending on the embodiment, instead of or in addition to a direct request from an external system, a triggering event can include a certain action taken in the property management system, the occurrence of a certain date/time, etc.

At block 1004, the processing logic can identify a workflow. In one embodiment, the workflow, such as workflow 404, corresponds to the property management task and includes a sequence of operations to be executed to perform the property management task. In one embodiment, the workflow includes a plurality of actions, a plurality of flow paths connecting the plurality of actions, and a plurality of textual descriptions describing each action of the plurality of actions. In one embodiment, the workflow is defined for the PMSS platform 170 in response to input received via at least one of a graphical user interface or an application programming interface.

At block 1006, the processing logic can generate a prompt, such as input prompt 402, based on the request, the workflow 404, and additional contextual data from the PMSS platform 170. In one embodiment, generating the prompt comprises identifying a textual description describing at least one action of the plurality of actions. For example, the prompt generated by PMSS platform 170 can relate to performing the property management task, and can be guided by the actions and flow paths of the pre-defined workflow 404. In one embodiment, an AI agent is instructed or trained to perform or suggest (parts of) a workflow. This can include taking into account database state, as well as conversational and other unstructured data sources to generate a next action. Actions can include engaging in a multi-turn conversation or performing property management tasks via API, outsourcing specific actions to specialized subagents, or escalating an action for human review. An AI agent may take actions via multiple steps, including a sequence of reasoning, tool calling, and tool response interpretation.

At block 1008, the processing logic can provide the prompt as an input to a generative AI model agent, such as LLM agent 124. The generative AI model agent can execute the sequence of operations to perform the property management task. In one embodiment the generative AI model agent is part of a hierarchy comprising a plurality of agents (e.g., other top-level LLM agents and/or a number of corresponding sub-agents, such as sub-agents 424.1, 424.2, 424.n), wherein each agent and/or sub-agent is associated with one or more individual actions of the plurality of actions defined in the workflow. In one embodiment, to execute the sequence of operations, the generative AI model agent is to perform the at least one action of the plurality of actions defined in the workflow. In another embodiment, the generative AI model agent can generate the list of actions and defer the execution of those actions to another component, such as another part of the property management system, or an external system.

At block 1010, the processing logic can obtain an output of the generative AI model agent, the output comprising a result of at least one action of the plurality of actions.

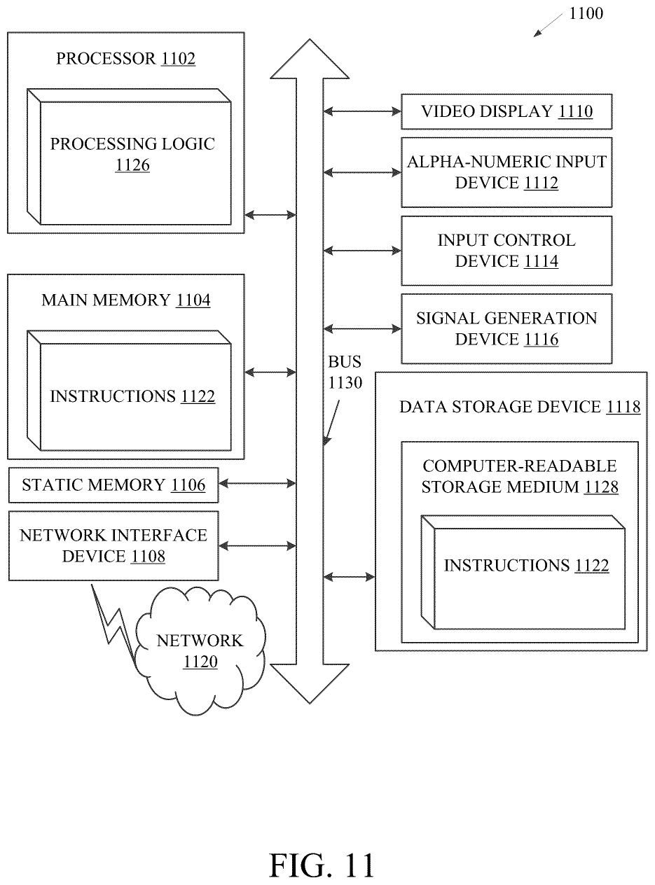

FIG. 11 illustrates a block diagram of an example processing device operating in accordance with implementations of the present disclosure.

In one implementation, the processing device 1100 may be a part of any device or system of FIG. 1, or any combination thereof. Example processing device 1100 may be connected to other processing devices in a LAN, an intranet, an extranet, and/or the Internet. The processing device 1100 may be a personal computer (PC), a set-top box (STB), a server, a network router, switch or bridge, or any device capable of executing a set of instructions (sequential or otherwise) that specify actions to be taken by that device. Further, while only a single example processing device is illustrated, the term “processing device” shall also be taken to include any collection of processing devices (e.g., computers) that individually or jointly execute a set (or multiple sets) of instructions to perform any one or more of the methods discussed herein.

Example processing device 1100 may include a processor 1102 (e.g., a CPU), a main memory 1104 (e.g., read-only memory (ROM), flash memory, dynamic random access memory (DRAM) such as synchronous DRAM (SDRAM), etc.), a static memory 1106 (e.g., flash memory, static random access memory (SRAM), etc.), and a secondary memory (e.g., a data storage device 1118), which may communicate with each other via a bus 1130.

Processor 1102 represents one or more general-purpose processing devices such as a microprocessor, central processing unit, or the like. More particularly, processor 1102 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1102 may also be one or more special-purpose processing devices such as an application specific integrated circuit (ASIC), a field programmable gate array (FPGA), a digital signal processor (DSP), network processor, or the like. In accordance with one or more aspects of the present disclosure, processor 1102 may be configured to execute instructions.

Example processing device 1100 may further include a network interface device 1108, which may be communicatively coupled to a network 1120. Example processing device 1100 may further include a video display 1110 (e.g., a liquid crystal display (LCD), a touch screen, or a cathode ray tube (CRT)), an alphanumeric input device 1112 (e.g., a keyboard), an input control device 1114 (e.g., a cursor control device, a touch-screen control device, a mouse), and a signal generation device 1116 (e.g., an acoustic speaker).

Data storage device 1118 may include a computer-readable storage medium (or, more specifically, a non-transitory computer-readable storage medium) 1128 on which is stored one or more sets of executable instructions 1122. In accordance with one or more aspects of the present disclosure, executable instructions 1122 may include executable instructions.

Executable instructions 1122 may also reside, completely or at least partially, within main memory 1104 and/or within processor 1102 during execution thereof by example processing device 1100, main memory 1104 and processor 1102 also constituting computer-readable storage media. Executable instructions 1122 may further be transmitted or received over a network via network interface device 1108.

While the computer-readable storage medium 1128 is shown in FIG. 11 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

It should be understood that the above description is intended to be illustrative, and not restrictive. Many other embodiment examples will be apparent to those of support module in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

The embodiments of methods, hardware, software, firmware, or code set forth above may be implemented via instructions or code stored on a machine-accessible, machine readable, computer accessible, or computer readable medium which are executable by a processing element. “Memory” includes any mechanism that provides (i.e., stores and/or transmits) information in a form readable by a machine, such as a computer or electronic system. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment, embodiment, and/or other exemplarily language does not necessarily refer to the same embodiment or the same example, but may refer to different and distinct embodiments, as well as potentially the same embodiment.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” throughout is not intended to mean the same embodiment or embodiment unless described as such. Also, the terms “first,” “second,” “third,” “fourth,” etc. as used herein are meant as labels to distinguish among different elements and may not necessarily have an ordinal meaning according to their numerical designation.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. The essential elements of a digital computer are a central processing unit for performing or executing instructions and one or more memory devices for storing instructions and digital data. The central processing unit and the memory can be supplemented by, or incorporated in, special purpose logic circuitry. Generally, a digital computer will also include, or be operatively coupled to receive digital data from or transfer digital data to, or both, one or more mass storage devices for storing digital data, e.g., magnetic, magneto-optical disks, optical disks, or systems suitable for storing information. However, a digital computer need not have such devices.

Digital computer-readable media suitable for storing digital computer program instructions and digital data include all forms of non-volatile digital memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks.

Control of the various systems described in this specification, or portions of them, can be implemented in a digital computer program product that includes instructions that are stored on one or more non-transitory machine-readable storage media, and that are executable on one or more digital processing devices. The systems described in this specification, or portions of them, can each be implemented as an apparatus, method, or system that may include one or more digital processing devices and memory to store executable instructions to perform the operations described in this specification.

While this specification contains many specific embodiment details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
receiving, from a client device connected to a property management software system (PMSS), a request associated with a property management task;
identifying a workflow corresponding to the property management task, the workflow comprising a sequence of operations;
generating a prompt based on the request, the workflow, and additional contextual data from the PMSS; and
providing the prompt as an input to a generative AI model agent, the generative AI model agent to execute the sequence of operations to perform the property management task.

2. The method of claim 1, wherein the workflow comprises:
a plurality of actions;
a plurality of flow paths connecting the plurality of actions; and
a plurality of textual descriptions describing each action of the plurality of actions.

3. The method of claim 2, wherein the workflow is defined for the PMSS in response to input received via at least one of a graphical user interface or an application programming interface.

4. The method of claim 2, wherein generating the prompt comprises identifying a textual description describing at least one action of the plurality of actions.

5. The method of claim 4, wherein the generative AI model agent is part of a hierarchy comprising a plurality of agents, wherein each agent is associated with one or more individual actions of the plurality of actions.

6. The method of claim 5, wherein to execute the sequence of operations, the generative AI model agent is to perform the at least one action of the plurality of actions.

7. The method of claim 6, further comprising:
obtaining an output of the generative AI model agent, the output comprising a result of the at least one action of the plurality of actions.

8. A system configured to execute a property management software system (PMSS), the system comprising:
memory; and
a processing device coupled to the memory to perform operations comprising:
receiving, from a client device connected to the PMSS, a request associated with a property management task;
identifying a workflow corresponding to the property management task, the workflow comprising a sequence of operations;
generating a prompt based on the request, the workflow, and additional contextual data from the PMSS; and
providing the prompt as an input to a generative AI model agent, the generative AI model agent to execute the sequence of operations to perform the property management task.

9. The system of claim 8, wherein the workflow comprises:
a plurality of actions;
a plurality of flow paths connecting the plurality of actions; and
a plurality of textual descriptions describing each action of the plurality of actions.

10. The system of claim 9, wherein the workflow is defined for the PMSS in response to input received via at least one of a graphical user interface or an application programming interface.

11. The system of claim 9, wherein generating the prompt comprises identifying a textual description describing at least one action of the plurality of actions.

12. The system of claim 11, wherein the generative AI model agent is part of a hierarchy comprising a plurality of agents, wherein each agent is associated with one or more individual actions of the plurality of actions.

13. The system of claim 12, wherein to execute the sequence of operations, the generative AI model agent is to perform the at least one action of the plurality of actions.

14. The system of claim 13, wherein the processing device is to perform operations further comprising:
obtaining an output of the generative AI model agent, the output comprising a result of the at least one action of the plurality of actions.

15. A non-transitory computer readable storage medium storing instructions which, when executed by a processing device, cause the processing device to perform operations comprising:
receiving, from a client device connected to a property management software system (PMSS), a request associated with a property management task;
identifying a workflow corresponding to the property management task, the workflow comprising a sequence of operations;
generating a prompt based on the request, the workflow, and additional contextual data from the PMSS; and
providing the prompt as an input to a generative AI model agent, the generative AI model agent to execute the sequence of operations to perform the property management task.

16. The non-transitory computer readable storage medium of claim 15, wherein the workflow comprises:
a plurality of actions;
a plurality of flow paths connecting the plurality of actions; and
a plurality of textual descriptions describing each action of the plurality of actions.

17. The non-transitory computer readable storage medium of claim 16, wherein the workflow is defined for the PMSS in response to input received via at least one of a graphical user interface or an application programming interface.

18. The non-transitory computer readable storage medium of claim 16, wherein generating the prompt comprises identifying a textual description describing at least one action of the plurality of actions.

19. The non-transitory computer readable storage medium of claim 18, wherein the generative AI model agent is part of a hierarchy comprising a plurality of agents, wherein each agent is associated with one or more individual actions of the plurality of actions.

20. The non-transitory computer readable storage medium of claim 19, wherein to execute the sequence of operations, the generative AI model agent is to perform the at least one action of the plurality of actions.
